(19) United States
(12) Patent Application Publication
(10) Pub. No.: US 2022/0377006 A1
(43) Pub. Date: Nov. 24, 2022

(54) TECHNIQUES FOR SAFE ACYCLIC ROUTING IN A COMMUNICATIONS NETWORK

(71) Applicant: The Regents of the University of California, Oakland, CA (US)

(72) Inventor: Jose Joaquin Garcia-Luna-Aceves, Santa Cruz, CA (US)

(21) Appl. No.: 17/743,722

(22) Filed: May 13, 2022

Related U.S. Application Data
(60) Provisional application No. 63/252,314, filed on Oct. 5, 2021.
(60) Provisional application No. 63/201,818, filed on May 14, 2021.

(51) Int. Cl. H04L 45/122; H04L 45/02; H04L 45/58

(52) U.S. Cl. CPC H04L 45/122; H04L 45/02; H04L 45/58

(57) ABSTRACT

Safe, fast, acyclic routing in a communications network includes receiving at a local router, from a first router, a request packet that indicates a first destination value. In response to the request, it is determined whether a first entry in a routing table data structure at the local router indicates the first destination value in a destination field and a valid value in a voucher field. The local router sends to the first router a response packet with a first distance value from a distance field of the first entry only when the voucher field holds a valid value. The local router forwards the request packet to a different second router when the voucher field holds an invalid value.

### CROSS-REFERENCE TO RELATED APPLICATIONS

This application claims benefit of Provisional Appln. 63/252,314, filed Oct. 5, 2021 and of Provisional Appln. 63/201,818, filed May 14, 2021, the entire contents of each of which are hereby incorporated by reference as if fully set forth herein, under 35 U.S.C. § 119(e).

### BACKGROUND

Networks of general-purpose computer systems connected by external communication links are well known and widely used in commerce. The networks often include one or more network devices that facilitate the passage of information between the computer systems. A network node is a network device or computer system connected by the communication links. An end node is a node that is configured to originate or terminate communications over the network. An intermediate network node facilitates the passage of data between end nodes.

Communications between nodes are typically effected by exchanging discrete packets of data. Information is exchanged within data packets according to one or more of many well known, new or still developing protocols. In this context, a protocol consists of a set of rules defining how the nodes interact with each other based on information sent over the communication links. Each packet typically comprises 1] header information associated with a particular protocol, and 2] payload information that follows the header information and contains information that may be processed independently of that particular protocol. In some protocols, the packet includes 3] trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different layer of detail for information exchange. The header for a particular protocol typically indicates a type for the next protocol contained in its payload. The higher layer protocol is said to be encapsulated in the lower layer protocol.

The headers included in a packet traversing multiple heterogeneous networks, such as the Internet, typically include a physical (layer 1) header, a data-link (layer 2) header, an internetwork (layer 3) header and a transport (layer 4) header, as defined by the Open Systems Interconnection (OSI) Reference Model. The OSI Reference Model is generally described in more detail in Section 1.1 of the reference book entitled Interconnections Second Edition, by Radia Perlman, published September 1999, which is hereby incorporated by reference as though fully set forth herein.

The internetwork header provides information defining the source and destination address within the network. Notably, the path may span multiple physical links. The internetwork header may be formatted according to the Internet Protocol (IP), which specifies IP addresses of both a source and destination node at the end points of the logical path. Thus, the packet may “hop” from node to node along its logical path until it reaches the end node assigned to the destination IP address stored in the packet's internetwork header.

Routers and switches are network devices that determine which communication link or links to employ to support the progress of data packets through the network. A network node that determines which links to employ based on information in the internetwork header (layer 3) is called a router. Some protocols pass protocol-related information among two or more network nodes in special control packets that are communicated separately and which include a payload of information used by the protocol itself rather than a payload of data to be communicated for another application. These control packets and the processes at network nodes that utilize the control packets are said to be in another dimension, a “control plane,” distinct from the “data plane” dimension that includes the data packets with payloads for other applications at the end nodes.

A link-state protocol is an example of a routing protocol, which only exchanges control plane messages used for routing data packets sent in a different routed protocol (e.g., IP). In a link-state protocol, two routers establish an adjacency relationship between them by first verifying direct two-way communication between them over the same network segment and then synchronizing their link-state databases. Link-state data describe all links to a router and describes the network addresses reachable on each of those links, as well as other properties of the link. Once the adjacency relationship is established, the two routers are called peers. During a reliable flooding stage of a link-state protocol, each router is required to ensure that each of its peers has received the link-state data describing the router's own links.

As a consequence, resources on each router and many other network nodes are consumed for each set of addresses associated with each link. The resources consumed by the router include: memory to store the addresses associated with each link; processor time to compute a route based, at least in part, on the addresses reachable over each link; and both processor time and link bandwidth for sending, receiving and processing routing information involving the link. Convergence is the term used to describe the condition when all routers in an internetwork have agreed on a common topology. Changes in network topology and initiation of convergence occurs whenever a node enters or leaves the network or changes neighbors.

A routing loop (or routing cycle) is a serious network problem which happens when a data packet is continually routed through the same set of devices over and over without ever reaching the packet's destination. Routing loops [temporary or permanent] exist in link-state routing protocols, distance-vector routing protocols and path-vector routing protocols. Routing loops continue to be a key area of research and product development today. A routing loop can happen in large internetworks when a second topology change emerges before the network is able to converge on a first change in network topology. A routing loop can have a catastrophic impact on a network, and in some cases, completely disable the network.

### SUMMARY

Techniques are provided for acyclic operation by augmenting distance information in routing tables and updates with distance vouchers and reference distances that are used together to attest that the paths associated with distances are acyclic (i.e., do not have routing loops). The first router that can satisfy a reference distance stated in a request attests for an acyclic path and generates a valid voucher. A router that must change its next hop to a destination can do so only if it has a neighbor with a valid voucher and a reported distance strictly smaller than that router's own reference distance.

In a first set of embodiments, a method for routing in a communications network includes receiving at a local router, from a first router, a request packet that indicates a first destination value. The method also includes, in response to the request, determining whether a first entry in a routing table data structure at the local router indicates the first destination value in a destination field and a valid value in a voucher field. The method further includes sending to the first router a response packet with a first distance value from a distance field of the first entry only when the voucher field holds a valid value. Still further, the method includes forwarding the request packet to a different second router when the voucher field holds an invalid value.

In some embodiments of the first set, the request packet also indicates a reference distance value. The sending the response packet to the first router is only performed if the voucher field holds the valid value and the reference distance value is greater than the first distance value.

In some embodiments of the first set, the method yet further includes receiving at the local router, from a third router, a response packet that indicates a second destination value and a valid or invalid value for a voucher and a second distance value. The method even further still includes, upon receiving the response packet, storing in the routing table data structure at the local router a second entry that indicates the second destination value in the destination field of the second entry and the valid or invalid value in the voucher field of the second entry and the second distance value in the distance field of the second entry.

In some embodiments of the first set, the method even further includes, upon detection at the local router of an invalidation event involving the second destination value based on the response packet indicating the invalid value, storing the invalid value in the voucher field in the second entry in the routing table data structure at the local router. In some of these embodiments, the local router sends a message to neighboring routers of the invalidation event.

In a second set of embodiments, a method for routing in a communications network includes receiving at a local router, from a first router, a response packet that indicates a first destination value, a valid or invalid value for a voucher and a first distance value. The method also includes storing in a routing table data structure at the local router a first entry that indicates the first destination value in a destination field of the first entry and the valid or invalid value in a voucher field of the first entry. When the valid value is stored in the voucher field and a reference distance field in a reference distance field of the first entry is greater than the first distance value, the method further includes determining a total distance value based on the first distance value and a link distance value indicating a distance between the local router and the first router and storing in the routing table data structure the total distance value in the distance field of the first entry.

In other sets of embodiments, a computer-readable medium or an apparatus is configured to perform one or more steps of one or more of the above methods.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1A is a block diagram that illustrates an example communication network, according to an embodiment;

FIG. 1B is a block diagram that illustrates an example of a network node in the network of FIG. 1A, according to an embodiment;

FIG. 2A and FIG. 2B are block diagrams that illustrate example packets, according to an embodiment;

FIG. 3A is a block diagram that illustrates an example of table data stored in the network node of FIG. 1B, according to an embodiment;

FIG. 3B is a block diagram that illustrates an example of a data structure of a routing table stored in the network node of FIG. 1B, according to an embodiment;

FIGS. 4A through 4C are block network message diagrams that illustrates example exchanges of messages, according to an embodiment;

FIGS. 5A and 5B are flow diagrams that illustrate an example of a method for routing in a communications network, according to an embodiment;

FIGS. 6A through 6F are block diagrams that illustrate an example of stages of achieving network convergence using the method of FIGS. 5A and 5B, according to an embodiment;

FIGS. 7A through 7F are block diagrams that illustrate an example of using the method of FIGS. 5A and 5B after a network is partitioned, according to an embodiment;

FIG. 8 is a block diagram that illustrates an example of using the method of FIGS. 5A and 5B after a link cost increase in the network, according to an embodiment;

FIG. 9 is a block diagram that illustrates a computer system upon which an embodiment of the invention may be implemented; and

FIG. 10 illustrates a chip set upon which an embodiment of the invention may be implemented.

### DETAILED DESCRIPTION

A method, software and apparatus are described for safe, fast acyclic routing. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5× to 2×, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of layer 3 Distance Value routing. However, the invention is not limited to this context. In other embodiments other routing cost functions are used in place of or in addition to distance and in layer 2 or layer 3 or above. For example, in some embodiments these methods are performed as an overlay, which one could view as layer 3+. Layer 2 is a promising approach for some ad hoc networks and Internet of things (IoT) deployments.

### 1. Structural Overview

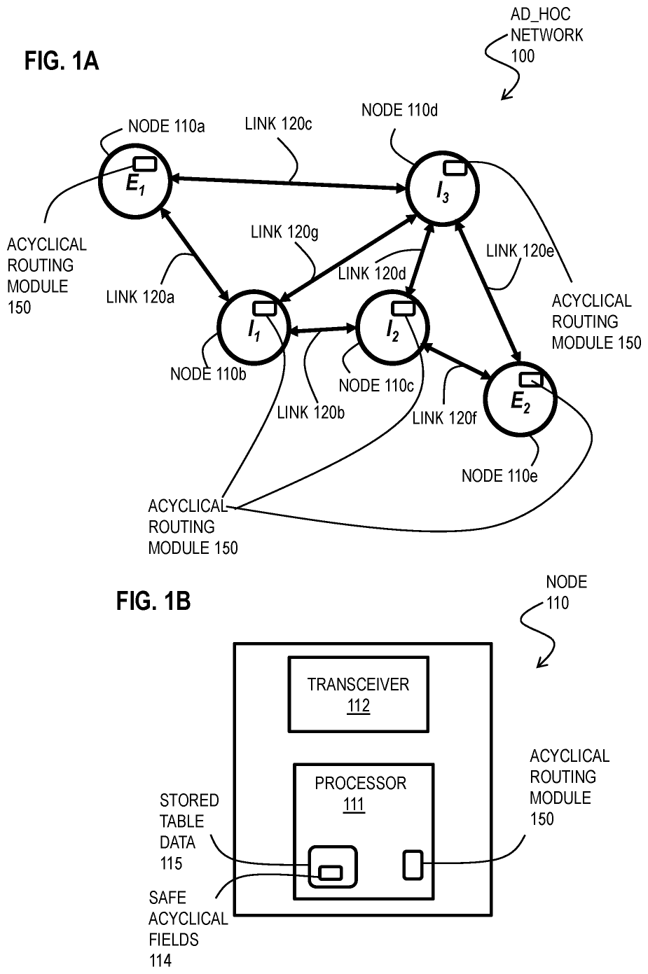

FIG. 1A is a block diagram that illustrates an example communication network system, according to an embodiment. The system includes a network 100 of interconnected communication devices (e.g., network nodes 110a through 110e) using wired or wireless single channel or multichannel connections 120a through 120g. Each of the network nodes 110a through 110e include one or more software modules that operate the network node and communicate with other network nodes in the network 100, as represented by the acyclical routing module 150 for the network 100.

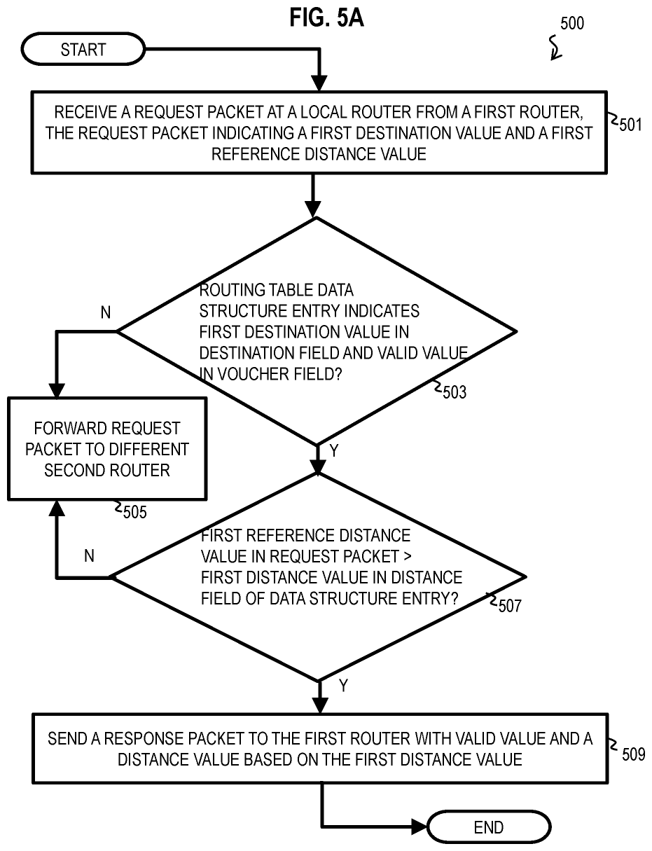

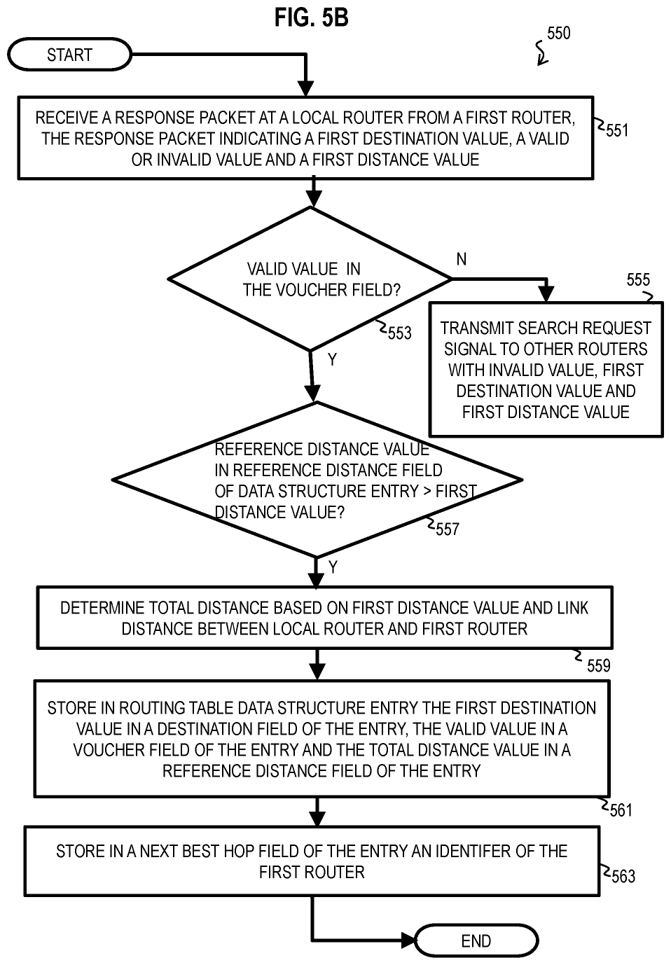

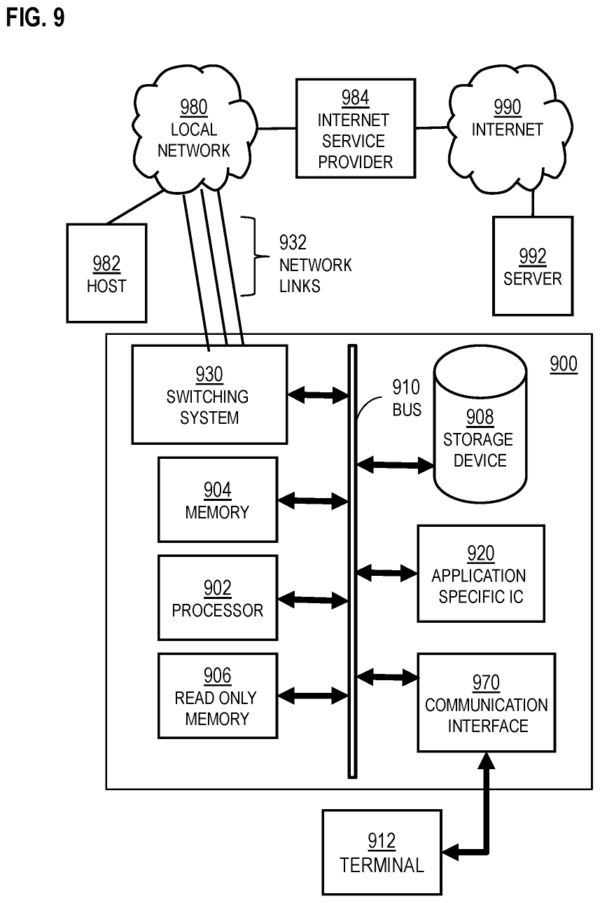

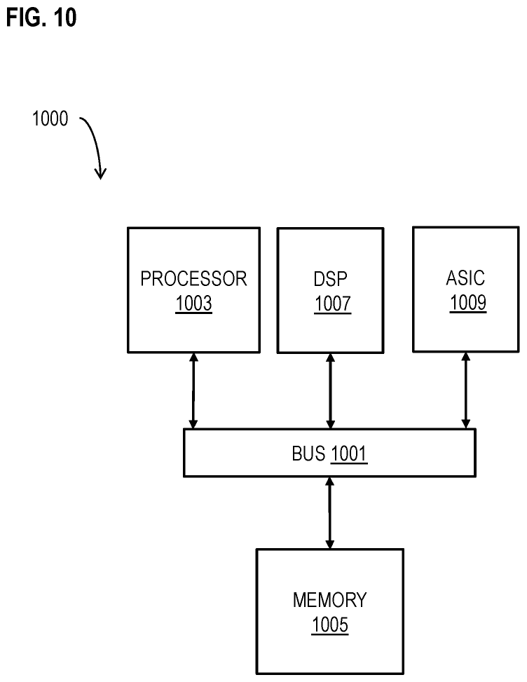

FIG. 1B is a block diagram that illustrates an example of a network node 110 in the network 100 of FIG. 1A, according to an embodiment. In an embodiment, the network node 110 is a router that determines which of the links 120 to employ based on information in the internetwork header (layer 3). The network node 110 includes a processor 111 that includes the acyclical routing module 150 to determine which of the links 120 to employ in transmitting data from a source (e.g., node 110e) to a destination (e.g., node 110a). In one embodiment, the acyclical routing module 150 causes one or more network nodes 110 to perform one or more steps of a method described below with reference to FIGS. 5A and 5B. In various embodiments, the network node 110 comprises one or more general purpose computer systems or upgraded computer systems that include processing units, as depicted in FIG. 9 or one or more chip sets as depicted in FIG. 10, and instructions to cause the computer or chip set to perform one or more steps of a method described below with reference to FIGS. 5A and 5B.

In an embodiment, the network node 110 stores table data 115 in a memory of the processor 111 (such as ROM 906 or memory 904 or storage device 908 in FIG. 9, or some combination) based on performing one or more of the steps of the method described below with respect to FIGS. 5A and 5B. In one embodiment, the stored table data 115 includes a routing table in which safe acyclical fields 114 are stored that indicate which of the links 120 to employ in transmitting data from the source node (e.g., node 110e) to the destination node (e.g., node 110a).

In an embodiment, the network node 110 includes a transceiver 112 (such as switching system 930 in FIG. 9) to transmit data packets to other network nodes 110 or receive data packets from other network nodes 110 over network links (such as network links 932 in FIG. 9) in the performance of one or more steps of the method described below with respect to FIGS. 5A and 5B. In one embodiment, the transceiver 112 is configured to transmit or receive control data packets that communicate data that indicate information in the internetwork header (layer 3). The transceiver 112 is communicatively coupled with the processor 111 (such as processor 902 in FIG. 9) so that the transceiver 112 is configured to transmit one or more control packets to other network nodes 110 based on data received from the processor 111 and is configured to receive one or more control packets from other network nodes 110 and communicate data based on the received control packets to the processor 111.

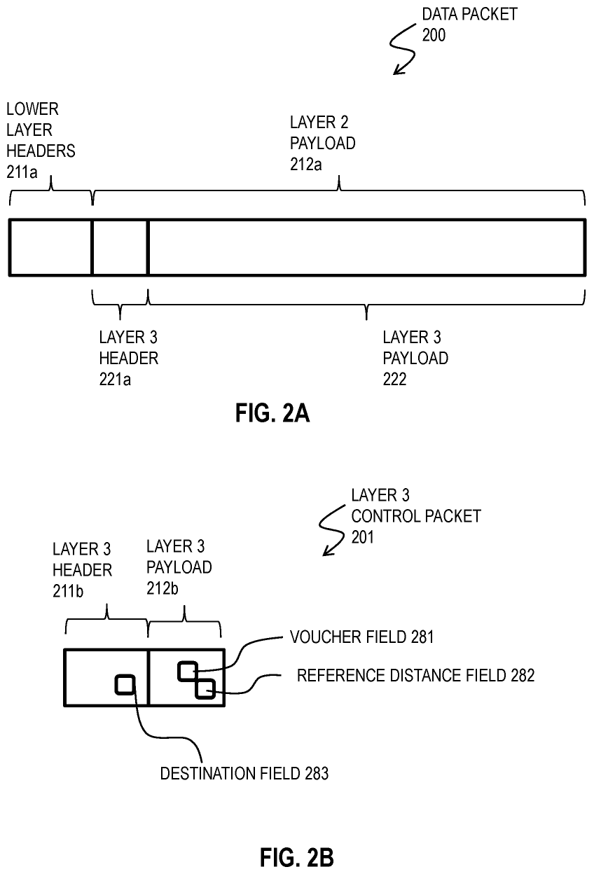

FIG. 2A and FIG. 2B are block diagrams that illustrate example packets with layer 3 and lower headers, according to an embodiment. FIG. 2A illustrates an example data packet 200 with data provided for a Layer 3 or higher layer protocol, including various transport protocols and application layers. Such data packets 200 include headers 211a made up of a series of bits that indicate values for various Layer 1 and Layer 2 fields, and a Layer 2 payload 212a. The Layer 2 payload 212a includes a Layer 3 header 221a that is made up of a series of bits that indicate values for various Layer 3 fields (such as origin and destination IP addresses), and a Layer 3 payload 222. The Layer 3 payload 222 includes a series of bits that indicate values for the various fields of the header and payload of the higher layer protocols encapsulated by the Layer 3 protocol. No further protocol needs to be illustrated to describe the various embodiments. In many embodiments, the Layer 3 protocol is the IP protocol. The data packets can be layer 4 (UDP/TCP as example) or layer 5 (HTTP for example).

FIG. 2B illustrates an example control plane packet 201 for the Layer 3 protocol. As for the data packet 200, the control plane packet 201 includes a Layer 3 header 211b and a Layer 3 control packet payload 212b. In various embodiments, the Layer 3 control packet 201 is modified to include additional fields to those conventionally used. The additional fields include one or more of a voucher field 281 and a reference distance field 282. Typically, the header 211b includes a destination field 283. The voucher field can hold a first value indicating valid (e.g., 1 or true) or a different value indicating invalid (e.g., 0 or false) and can thus, in some embodiments, be implemented as a single bit. The reference distance 282 field holds data that indicates the minimum cost (e.g., number of hops or other measure of distance) to go from the sending router to the destination router. The destination field 283 holds data that indicates a destination (e.g., destination node in the network). In one embodiment, the valid value in the voucher field 281 indicates that the network node 110 that transmitted the control packet 201 attests an acyclical path to the destination indicated by the destination field 283, where the acyclical path has a distance indicated by the reference distance field 282.

Although processes, equipment, and data structures are depicted in FIGS. 1A and 1B as integral blocks in a particular arrangement for purposes of illustration, in other embodiments one or more processes or data structures, or portions thereof, are arranged in a different manner, on the same or different hosts, in one or more databases, or are omitted, or one or more different processes or data structures are included on the same or different hosts

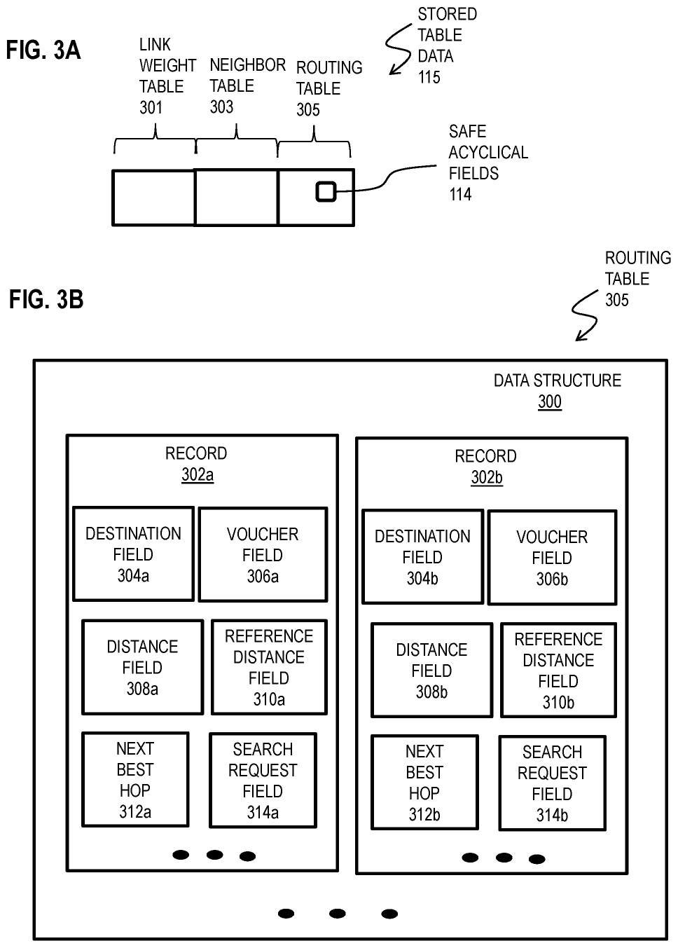

Although data structures, messages and fields are depicted in FIG. 2A, and subsequent diagrams in FIG. 2B and FIGS. 3A through 3B, as integral blocks in a particular order for purposes of illustration, in other embodiments, one or more data structures or messages or fields, or portions thereof, are arranged in a different order, in the same or different number of data structures or databases in one or more hosts or messages, or are omitted, or one or more additional fields are included, or the data structures and messages are changed in some combination of ways.

In an embodiment, each network node 110 includes one or more data structures in the memory of the processor 111, to store the table data 115 that includes the safe acyclical fields 114 (e.g., that indicates which of the links 120 to employ in transmitting data along an acyclical path from a source node to a destination node). In an embodiment, each respective network node 110 includes the table data 115 which stores one or more parameter values with respect to that respective network node 110.

FIG. 3A is a block diagram that illustrates an example of table data stored in the network node of FIG. 1B, according to an embodiment. In this embodiment, the table data 115 includes a link weight table 301 that stores data that indicates a value of a weight of one or more links 120 to neighbor nodes 110 (e.g., the link weight table 301 at network node 110b stores data that indicates the value of the weight of the links 120a and 120b to respective neighbor nodes 110a, 110c).

In an embodiment, the table data 115 includes a neighbor table 303 at each network node 110 that stores data that indicates one or more parameter values reported by neighbor nodes 110. In one embodiment, the parameter values include one or more of a distance value (e.g., that indicates a distance from the respective neighbor node to a destination node) and a voucher field (e.g., that indicates a binary value as with the voucher field 281 which indicates 1 or True to attest that the distance value from the neighbor node to the destination node is acyclical and 0 or False to not attest that the distance value from the neighbor node to the destination node is acyclical).

In an embodiment, the table data 115 includes a routing table 305 that stores data such as the safe acyclical fields 114 that indicate which communication links to employ that ensure an acyclical path of data packets through the network 100 (e.g., from a source node 110e to a destination node 110a). In an example embodiment, the safe acyclical fields 114 stored at each network node 110 indicate a next network node (or “next best hop”) to send data packets along the acyclical path from the source node to the destination node. In an example embodiment, a network node 110 stores the routing table 305 data that is provided in the layer 3 payload 212b (e.g., internetwork header) of control packets 201 sent from the network node 110 during the method described herein.

In one embodiment, the routing table 305 data is stored in a data structure. FIG. 3B is a block diagram that illustrates an example of a data structure 300 of the routing table 305 stored in the network node of FIG. 1B, according to an embodiment. In an embodiment, the data structure 300 includes one or more records such as 302a and 302b among others indicated by ellipsis and collectively referenced as records 302, where each record 302 is based on a respective destination and thus is based on a respective path for data packets in the network 100. In one embodiment, a first record 302a is stored in the data structure 300 that is based on a first destination value stored in a destination field 304a of the first record 302a. In another embodiment, a second record 302b is stored in the data structure 300 that is based on a second destination value stored in a destination field 304b of the second record 302b. Destination fields 304a and 304b among others are collectively referenced as destination fields 304.

In some embodiments, each record 302 includes one or more fields to hold data in addition to the destination field 304. In an embodiment, each record 302 includes a voucher field (such as fields 306a and 306b, among others, collectively referenced as voucher field 306) that indicates whether the reference distance value stored in the reference distance field 310 is attested as acyclical (e.g., whether the reference distance value from a first network node 110c where the record 302 is stored to a destination node 110a stored in the destination field 304 is attested as acyclical). In one embodiment, the voucher field 306 indicates a binary value, including 1 or True if the reference distance value stored in the reference distance field 310 is acyclical or 0 or False if the reference distance value stored in the reference distance field 310 is not acyclical.

In another embodiment, each record 302 includes a distance field (such as fields 308a and 308b, among others, collectively referenced as distance field 308) which indicates a value of a minimum distance from a network node (e.g., node 110c) where the routing table 305 data is stored to the destination (e.g., node 110a) indicated by the destination field 304. In another embodiment, each record 302 includes a reference distance field (such as fields 310a and 310b, among others, collectively referenced as reference distance field 310) that indicates a value of an attested acyclical distance (e.g., when the value of the field 306 is 1 or True) from the network node (e.g., node 110c) where the routing table 305 data is stored to the destination (e.g., node 110a). In another embodiment, each record 302 includes a next best hop field (such as fields 312a and 312b, among others, collectively referenced as next best hop field 312) that identifies a next network node (e.g., node 110b) from which data packets are to be transmitted from the network node (e.g., node 110c) where the routing table 305 is stored to ensure the acyclical path to the destination (e.g., node 110a).

In yet another embodiment, each record 302 includes a search request field (such as fields 314a and 314b, among others, collectively referenced as search request field 314) that indicates one or more parameter values of a search message sent to neighboring nodes for purposes of identifying a next network node (or “next best hop”) to ensure the acyclical path from the same network node where the routing table 305 data is stored or from a different network node 110. In an example embodiment, the search request field 314 indicates one or more of the destination value in the destination field 304, the voucher value in the voucher field 306 and the reference distance value in the reference distance field 310. In one embodiment, the data stored in the search request field 314 is utilized by the network node 110c to determine values for the layer 3 payload 212b of the control packet 201 that is sent to other network nodes 110b, 110d for purposes of determining whether one of the other network nodes 110b, 110d can serve as a next network node (or “next best hop”) to ensure the acyclical path from the network node 110c to the destination node 110a.

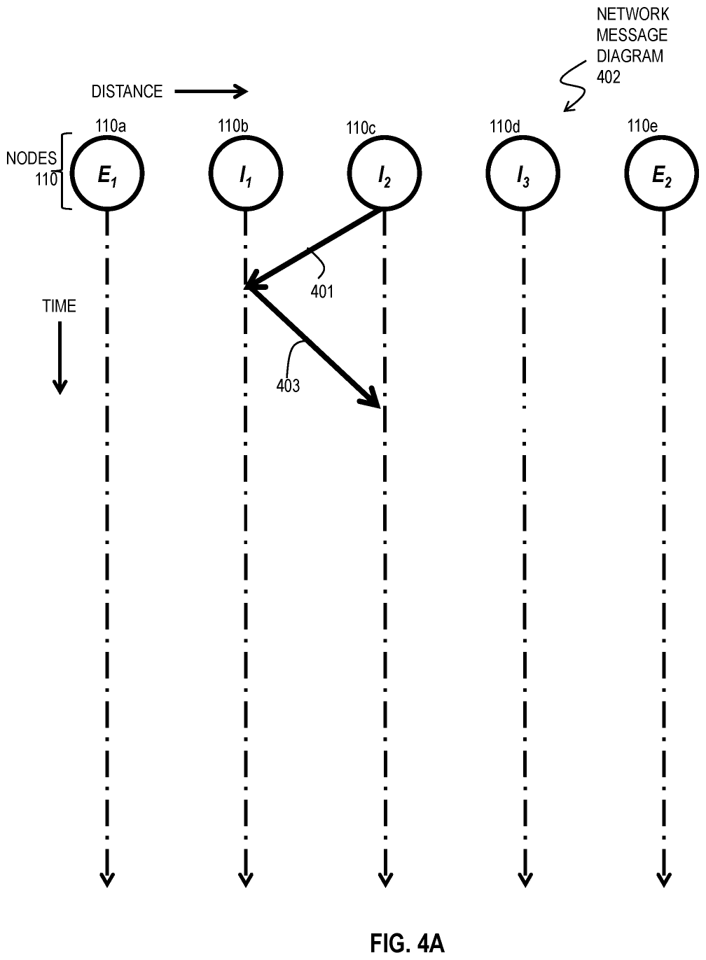

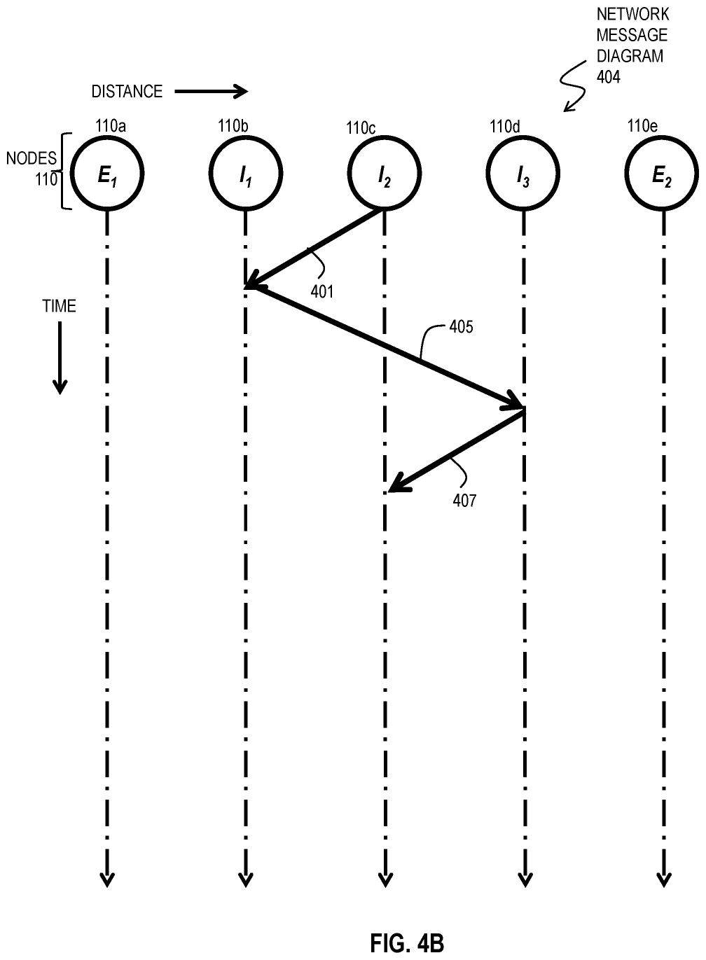

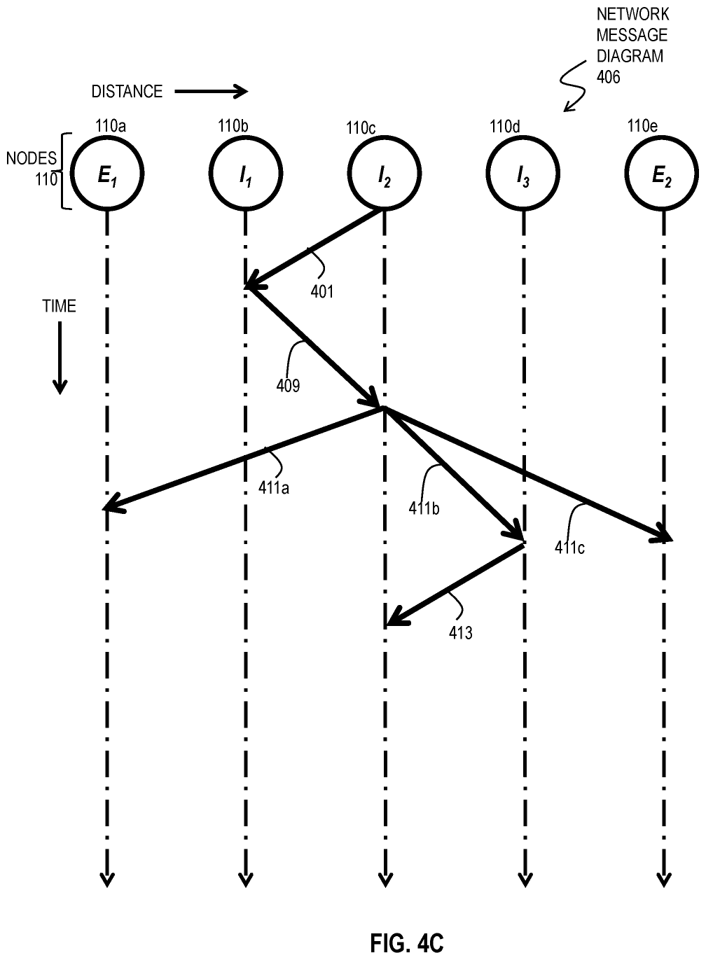

Some example embodiments of control data packets exchanged between network nodes 110 of the network 100 are now discussed. FIGS. 4A through 4C are block network message diagrams that illustrates example exchanges of messages between nodes 110 of the network 100, according to an embodiment. In FIGS. 4A through 4C, distance is indicated by spacing in the horizontal dimension, and time is indicated in the vertical dimension, increasing downward. A message is initiated at one instant at one node and spreads to the one or more adjacent nodes, arriving at a later time representing propagation delay. Propagation delay is very small, on the order of a microsecond or less. Because propagation delay is so small, the vertical separation is not drawn to scale. Additionally, although FIGS. 4A through 4C depict the nodes 110 equally spaced in the horizontal dimension, the nodes 110 need not be equally spaced apart.

In an embodiment, the first network message diagram 402 of FIG. 4A depicts a scenario where a network node 110c (12 in FIG. 1A and FIG. 4A) determines that a neighbor node 110b (I1 in FIG. 1A and FIG. 4A) can attest for an acyclical path to the destination node 110a (Ei in FIG. 1A and FIG. 4A) and thus can serve as a “next hop” from the network node 110c to the destination node 110a. In an embodiment this is accomplished when a first control packet 401 is transmitted from the network node 110c (12 in FIG. 1A). The control packet 401 includes the voucher field 281, the reference distance field 282 and the destination field 283. In one embodiment, the destination field 283 includes the destination value stored at the node 110c in the destination field 304a of the record 302a that is associated with the destination (e.g., node 110a or E₁). The voucher field 281 includes the voucher value stored in the voucher field 306a of the record 302a that is associated with the destination on node 110c or I₂. The reference distance field 282 includes the reference distance value stored in the reference distance field 310a of the record 302a associated with the destination on node 110c or I₂.

In this embodiment, the neighbor node 110b (I₁ in FIG. 1A) receives the first control packet 401. The neighbor node 110b then determines whether a record 302 stored at the neighbor node 110b has a destination value in the destination field 304 that corresponds to the destination field 283 of the control packet 401. The neighbor node 110b then determines whether the voucher value of the voucher field 306 of this record 302 has a valid value. If these two determinations are in the affirmative, the neighbor node 110b assesses whether the reference distance value stored in the reference distance field 310 of this record 302 is less than the reference distance value in the reference distance field 282 of the control packet 401. If this assessment is in the affirmative, the neighbor node 110b generates a response control packet 403 to send to the node 110c. In an embodiment, the response control packet 403 is to indicate to the node 110c that the neighbor node 110b attests for an acyclical path to the destination whose distance is less than the acyclical path from the node 110c to the destination. In this embodiment, the response control packet 403 includes the destination field 283 that indicates the destination value in the original control packet 401; the voucher field 281 that indicates the valid voucher value in the voucher field 306 of the record 302 stored at the neighbor node 110b; and the reference distance field 282 that indicates the value of the reference distance value in the reference distance field 310 of the record 202 stored at the neighbor node 110b.

In this embodiment, upon the network node 110c receiving the response control packet 403, the network node 110c assesses whether the response control packet 403 indicates that the neighbor node 110b is a next best hop to the destination. In the depicted embodiment, the network node 110c verifies that the voucher field 281 indicates the valid voucher and that the destination field 283 indicates the same destination value that was in the control packet 401 previously transmitted by the network node 110c. The network node 110c then confirms whether the reference distance value in the reference distance field 282 of the response control packet 403 is less than the reference distance value stored in the reference distance field 310 at the node 110c for the record 302 that corresponds to the destination. The node 110c then determines a total distance from the node 110c to the destination based on the reference distance value in the reference distance field 282 and a distance of a link between the node 110c and the neighbor node 110b (e.g., stored in the link weight table 301 at the node 110c). The node 110c then stores this total distance in the reference distance field 310 for the record 302 corresponding to the destination node 110a and stores the valid voucher value in the voucher field 306 of the same record 302. In this embodiment, the total distance value now stored in the reference distance field 310 of the record 302 indicates an attested acyclical distance of a path from the node 110c to the destination node 110a using the neighbor node 110b as a next hop. In another embodiment, the node 110c stores an identity of the neighbor node 110b (e.g., an identifier of the neighbor node 110b) in the next best hop field 312 of the record 302 corresponding to the destination.

In another embodiment, the second network message diagram 404 of FIG. 4B depicts a scenario where the neighbor node 110b (I₁ in FIG. 1A) determines that it cannot attest for an acyclical path to the destination node 110a and thus forwards the control packet 401 to a different neighbor node 110d (I₃ in FIG. 1A). In an embodiment, upon receiving the first control packet 401, the neighbor node 110b determines that the data structure 300 of the routing table 305 stored at the neighbor node 110b does not have a record 302 with a destination field 304 that includes the destination value in the destination field 283 of the control packet 401. In another embodiment, upon receiving the first control packet 401, the neighbor node 110b determines that the data structure 300 of the routing table 305 stored at the neighbor node 110b does have a record 302 with a destination field 304 that includes the destination value in the destination field 283 but that the voucher value of the voucher field 306 of that record 202 is invalid (e.g., 0 or False). Thus, in these embodiments, the neighbor node 110d determines that it cannot attest for an acyclical path to the destination node 110a in the destination field 283 of the control packet 401.

In this embodiment, based on this determination that the neighbor node 110b cannot attest for an acyclical path to the destination, the neighbor node 110b forwards the control packet 401 (as a new control packet 405) to a different neighbor node 110d (I₃ in FIG. 1A). In one embodiment, the different neighbor node 110d then processes the control packet 405 in a similar manner as the neighbor node 110b processed the control packet 401 with respect to FIG. 4A to determine the that the different neighbor node 110d can attest for an acyclical path to the destination. In this embodiment, the different neighbor node 110d then transmits a response control packet 407 to the node 110c in a similar manner as the neighbor node 110b transmitted the response control packet 403 to the node 110c in the first network message diagram 402. As with the first network message diagram 402, the node 110c then confirms whether the different neighbor node 110d can attest for an acyclical path to the destination and determines the total distance which is stored in the reference distance field 310 of the record 302 corresponding to the destination. Additionally, in an embodiment, the node 110c stores an identity of the different neighbor node 110d (e.g., an identifier of the neighbor node 110d) in the next best hop field 312 of the record 302 corresponding to the destination.

In another embodiment, the third network message diagram 406 of FIG. 4C depicts a scenario where the node 110c determines an invalidation event. In one embodiment the invalidation event is determined by the node 110c based on not receiving a response packet 403 from the neighbor node 110b after sending the request packet 401 to the neighboring node 110b. In this example embodiment, the failure to receive the response packet 403 indicates that the link between the nodes 110b to 110c may not be available for transmitting data packets to the destination. In another embodiment shown in FIG. 4C, the invalidation event is determined by the node 110c based on receiving the response packet 409 from the neighbor node 110b with an invalid value in the voucher field 281 of the response packet 403, thus indicating that the neighbor node 110b cannot attest for an acyclical path to the destination.

In the depicted embodiment, upon determining an invalidation event, the node 110c stores an invalid value in the voucher field 306 of the record 302 corresponding to the destination. In one embodiment, the node 110c also generates request control packets 411a, 411b, 411c to be sent to other neighbor nodes and/or other nodes in the network 100 in an attempt to determine whether another node in the network can attest for an acyclical path to the destination. As shown in FIG. 4C, in one embodiment the node 110c transmits the first request control packet 411a to the node 110a; transmits the second request control packet 411b to the node 110d and transmits the third request control packet 411c to the node 110e. In this embodiment, a link (not shown in FIG. 1A) is provided between the node 110a and node 110c, to transmit the first request control packet 411a. In one embodiment, the request control packets 411a, 411b, 411c each have the destination value from the destination field 304 of the record 302 in the destination field 283; the invalid value in the voucher field 281 and the reference distance value from the reference distance field 310 stored in the record 302 in the reference distance field 282. In an example embodiment, the request control packets 411a, 411b, 411c communicate to the other nodes 110a, 110d, 110e that the node 110c does not have an acyclical path to the destination and is prompting these nodes whether they can attest for an acyclical path to the destination.

In this embodiment, each of the nodes 110a, 110d, 110e process the request control packets 411a, 411b, 411c in a similar manner as the node 110d processed the request control packet 401 in the first network message diagram 402 of FIG. 4A. As shown in FIG. 4C, in one embodiment the neighbor node 110d determines that it can attest for an acyclical path to the destination with a reference distance value that is less than the reference distance value in the reference distance field 282 of the request control packet 411b. The neighbor node 110d consequently transmits a response control packet 413 to the node 110c with a valid value in the voucher field 281, the destination in the destination field 283 and the reference distance value stored in the reference distance field 310 in the record 302 at the neighbor node 110d that corresponds to the destination in the destination field 283. Upon receiving the response control packet 413 at the node 110c, the node 110c determines that the neighbor node 110d attests for an acyclical path to the destination. The node 110c subsequently stores a valid value in the voucher field 306 of the record 302 whose destination field 304 holds the destination and stores a total distance value in the reference distance field 310 of the same record 302. In this example embodiment, the total distance value is based on a sum of the reference distance value in the reference distance field 282 of the response control packet 413 and a link distance between the nodes 110c, 110d.

In an embodiment, when the node 110c receives multiple response control packets from multiple nodes that attest for respective acyclical paths, the node 110c selects the node with the smallest attested acyclical path to the destination as the next hop to the destination. Thus, in an example embodiment, if the node 110c receives multiple response control packets 413 from multiple nodes, where each response control packet includes a valid value in the voucher field 281 and a reference distance value in the reference distance field 282, the node 110c uses the minimum value among the reference distance values in the response control packets when determining the total distance value stored in the reference distance field 310. This ensures that the reference distance field 310 holds a smallest reference distance value that is attested as acyclical among the neighbor nodes.

A method for routing in communications network is now discussed in order to determine an acyclical path (e.g., safe acyclical fields 114) through the communications network from a source node to a destination node. Although steps are depicted in FIG. 5A, and in subsequent flowchart FIG. 5B, as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

FIG. 5A is a flow diagram that illustrate an example of a method 500 for routing in the communications network 100, according to an embodiment. In step 501 a request control packet is received at a node (e.g., router) of the network 100. For example, in step 501 the request control packet 401 is received at the neighbor node 110b and includes a destination value (e.g., node 110a) in the destination field 283, a voucher value (e.g., 1 or True) in the voucher field 281 and a reference distance value in the reference distance field 282. In an embodiment, prior to step 501 the node 110c generated the request control packet 401 and transmitted the request control packet 401 to the neighbor node 110b. In this example embodiment, in step 501 the request control packet 401 (e.g. destination value in the destination field 283, voucher value in the voucher field 281, reference distance value in the reference distance field 282, etc.) is received at the neighbor node 110b.

In an embodiment, in step 503 the data structure 300 of the routing table 305 stored at the node 110b is searched based on the data in the request control packet received in step 501. In one embodiment, in step 503 the processor 111 determines whether the data structure 300 includes a record 302 where the destination value stored in the destination field 304 corresponds to the destination value in the destination field 283 of the request control packet received in step 501. This determination establishes whether the data structure 300 stored at the node 110b includes a record 302 for the destination value in the destination field 283. In some embodiments, in step 503 the processor 111 then determines whether the voucher value of the voucher field 306 in the record 302 for the destination value indicates a valid value. This determination establishes whether the node 110b can attest for an acyclical path to the destination value stored in the destination field 283 of the request control packet received in step 501. If this determination is in the affirmative, the method 500 proceeds to block 507, otherwise the method 500 proceeds to block 505.

In step 505 the node 110b forwards the request control packet received in step 501 to a different node (e.g., different router). For example, step 505 is performed when the node 110b cannot attest for an acyclical path to the destination value and thus forwards the request control packet received in step 501 to a different node to determine whether the different node can attest for such an acyclical path to the destination. In this example embodiment, in step 505 the request control packet 405 of FIG. 4B is forwarded from the node 110b to a different node 110d after a determination was made that the node 110b cannot attest for an acyclical path to the destination. In this example embodiment, steps 501 and 503 are then repeated at the different node 110d upon receiving the forwarded request control packet 405.

In step 507 the node 110b determines whether the reference distance value in the reference distance field 282 is greater than the reference distance value stored in the reference distance field 310 of the record 302 at the node 110b for the destination value in the destination field 283. If this determination is in the negative, the method proceeds to block 505. For example, in block 505 the node 110b forwards the request control packet 405 to a different neighbor node 110d, as shown in FIG. 4B. The request control packet 405 is forwarded to the different neighbor node 110d since the current neighbor node 110b cannot attest for an acyclical path to the destination that has a distance that is less than the attested acyclical path from the node 110c to the destination (e.g., the reference distance value in the reference distance field 283).

If the determination in step 507 is in the affirmative, then the receiving node has confirmed that it can attest to an acyclical path to the destination that is less than the attested acyclical path from the requesting node to the destination. The method then moves to step 509. In step 509 the receiving node (e.g., node 110b) transmits the response control packet 403 to the requesting node (e.g., node 110c) to indicate this confirmation, as shown in FIG. 4A. In an embodiment, the steps taken by the requesting node (e.g., node 110c) upon receiving the response control packet 403 are discussed in the method 550 of FIG. 5B.

FIG. 5B is a flow diagram that illustrate an example of a method 550 for routing in the communications network 100, according to an embodiment. In step 551 a node (e.g., router) sends a request control packet for a route to a destination and in response receives a response control packet from another node (e.g., router). In step 551 the node (e.g., node 110c) receives the response control packet 403 (e.g., with a valid value in the voucher field 281) from the neighbor node (e.g., node 110b). In another embodiment, in step 551 the node 110c receives the response control packet 409 (e.g., with the invalid value in the voucher field 281) from the neighbor node (e.g., 110b).

In step 553 the node that received the response control packet in step 501 determines whether the voucher value of the voucher field 281 in the response control packet has a valid value. For example, in step 553 the node 110c receives the response control packet 401 or 409 and determines whether the voucher value in the voucher field 281 of the response control packet 401 or 409 is the valid value. If this determination is in the affirmative, the method 550 continues to block 557. If this determination is in the negative, the method 550 proceeds to block 555.

In step 555 the node that received the response control packet from a neighbor node has determined that the neighbor node cannot attest for an acyclical path to the destination. Thus, in step 555 the node transmits a signal to other nodes in the network to see if any of these other nodes can attest to an acyclical path to the destination. For example, in step 555 the node 110c received the response control packet 409 from the neighbor node 110b and determined that the neighbor node 110b cannot attest for an acyclical path to the destination 110a. In this example, in step 555 the node 110c transmits the request control packets 411a, 411b, 411c to other nodes 110a, 110d, 110e in the network 100. These request control packets 411a, 411b, 411c each include an invalid value in the voucher field 281, the destination (e.g., node 110a) in the destination field 283 and the reference distance value stored in the reference distance field 310 in the record 302 at the node 110c associated with the destination in the reference distance field 282.

In response, one of the nodes (e.g., 110d) transmits a response control packet 413 (FIG. 4C) back to the requesting node (e.g., 110c) if the responding node (e.g., 110d) can attest for an acyclical path to the destination that is less than the reference distance value in the reference distance field 282 of the request control packet 411b.

In step 557 the node that received the response control packet from a neighbor node determines whether the reference distance value stored in the reference distance field 310 of the record 302 at the node is greater than the reference distance value in the reference distance field 282 of the response control packet. For example, in step 557 the node 110c receives the response control packet 403 from the neighbor node 110b and determines whether the reference distance value stored in the reference distance field 310 of the record 302 at the node 110c is greater than the reference distance value in the reference distance field 282 of the response control packet 403. This determination in step 557 determines whether or not the neighbor node (e.g., node 110b) can attest for an acyclical path to the destination (e.g., node 110a) that is less than the attested acyclical path of the requesting node (e.g., node 110c). For example, this determination indicates that the neighbor node 110b may be a candidate for a next best hop to the destination 110a from the node 110c.

In step 559 the node determines a total distance to the destination based on the distance of the attested acyclical path from the neighbor node to the destination (e.g., reference distance value in the reference distance field 282 of the response control packet) and a distance of a link between the node and the neighbor node. For example, in step 559 the node 110c determines the total distance to the destination node 110a based on a sum of the distance of the attested acyclical path from the neighbor node 110b to the destination 110a (e.g., reference distance value in the reference distance field 282 of the response control packet 403) and a distance of a link between the nodes 110b, 110c (e.g., stored in the neighbor table 303 at the node 110c).

In step 561 the node stores data in the data structure 300 in an entry or record 302 corresponding to the destination. For example, in step 561 the node 110c stores the destination value for node 110a in the destination field 304 of the record 302; stores the valid value in the voucher field 306 of the record 302; and stores the total distance value from step 559 in the reference distance field 310 of the record 302.

In an embodiment, in step 561 the node stores additional data in the record 302 corresponding to the destination. For example, in step 561 the node 110c stores an identifier of the neighbor node 110b (e.g., a letter or number identifier of the node 110b) in the next best hop field 312 of the record 302. The next best hop fields 312 of the records 302 in the data structure 300 for those nodes that transmit data across the network from the source to the destination define the safe acyclical fields 114.

In an embodiment, the methods 500, 550 of FIGS. 5A and 5B are then repeated for the next best hop (e.g., node 110b) to the destination and thus the method is repeated for each node along the acyclical path from the source node (e.g., node 110e) to the destination node (e.g., node 110a). In an example embodiment, the next best hop values in the next best hop fields 312 among the source node, the destination node and the intermediate nodes between the source and destination nodes define the safe acyclical fields 114 as they indicate the nodes along the attested acyclical path from the source node to the destination node.

### 2. Example Embodiments

### 2.1 Data Packets and Stored Table Data

In an embodiment, the data packets (e.g., control data packets, request packet, response packets, etc.) transmitted between the routers or nodes 110 of the network 100 are update messages that are transmitted between the nodes 110 to update their routing information. In one embodiment, the update message includes multiple data fields that communicate to the other nodes in the network a status of the node that transmits the update message. In an embodiment, data packet from a router k is denoted by M^{k} and contains an identifier k of the router. In this embodiment, the data packet includes one or more updates. In an example embodiment, an update message from router k is a tuple denoted by U(d, n_{d}^{k}, ϑ_{d}^{k}, ρ_{d}^{k}, δ_{d}^{k}) where d is the destination field 283 or destination identifier; n_{d}^{k} is an identifier of the router recipient of the update message; ϑ_{d}^{k} is the voucher field 281 or distance voucher with the Boolean value; ρ_{d}^{k} is the reference distance field 282 or reference distance that states the distance of an attested acyclic path if ϑ_{d}^{k}=T or the maximum requested distance of an acyclic path being requested if ϑ_{d}^{k}=F; δ_{d}^{k} is a value from the distance field 308, namely a minimum distance from router k to destination d.

In an embodiment, the following conventions are used to interpret the information carried in an update message. n_{d}^{k}=0 denotes all neighbors of router k; n_{d}^{k}=k with d=k indicates that the update message is a “hello” to refresh the presence of router k; n_{d}^{k}=q≠k indicates that q is the primary recipient of the update message; however, all routers receiving the update message process it.

In an embodiment, each router k knows its own identifier (k) and maintains the Link-Weight Table 301 (LWT^{k}), the Neighbor Table 303 (NT^{k}), the Routing Table 305 (RT^{k}), and its initialization status (σ^{k}). In on embodiment, the LWT^{k} 301 lists a record or entry for each link to a known neighbor router n∈N^{k}. The entry for link (k, n) in the LWTk 301 states: (a) the weight l(k, n) of the link and (b) a lifetime LTₙ^{k} for the neighbor entry of router n. The maximum lifetime of a neighbor entry is a constant LT defined for the network 100.

In an embodiment, the NTₖ 303 lists the reference distance value (from the reference distance field 282) and the voucher value (from the voucher field 281) reported by each neighbor router for each destination value (from the destination field 283). The entry in NTₖ 303 for destination d at router k is denoted by NT^{k}(d) and specifies for each neighbor p∈N^{k} the latest reference distance value δ_{dp}^{k} from the p neighbor router to the destination d and the latest voucher value ϑ_{dp}^{k} for the p neighbor router. In one embodiment, in step 501 if a router does not receive a response packet from a neighbor router q with a reported reference distance to the destination d, then router k assumes that the reference distance value for the neighbor q δ_{dp}^{k}=δ_{∞} where δ_{∞} means a distance assumed for an unreachable destination and the voucher value ϑ_{dq}^{k}=T.

In an embodiment, the RT^{k} 305 lists a record 302 for each destination d for which the router must maintain routing information. The record 302 in RT^{k} for destination d is denoted by RT^{k}(d). In one embodiment, the record 302 includes one or more of r_{d}^{k} that is the reference distance value stored in the reference distance field 310; δ_{d}^{k} that is the minimum distance value stored in the distance field 308; ϑ_{d}^{k} that is the voucher value stored in the voucher field 306; s_{d}^{k} that is a next best hop that is stored in the next best hop field 312, with s_{d}^{k}=0 denoting the case that there is no next hop to d; S_{d}^{k} that is a set of neighbor routers that in addition to s_{d}^{k} satisfy equation 1 and is stored in an additional field (not shown in FIG. 3B); [p_{d}^{k}, λ_{d}^{k}] is a search tuple stored in the search request field 314 of the record 302 where p_{d}^{k} denotes the router or routers that sent a search request for d, and λ_{d}^{k} is the smallest reference distance stated in an ongoing search regarding d. In one embodiment, the search tuple is used to generate the search request control packets 411a, 411b, 411c. In one embodiment, a search tuple [p_{d}^{k}, λ_{d}^{k}] is interpreted as follows: p_{d}^{k}=0 and λ_{d}^{k}=δ_{∞}, states that router k is not part of an active search regarding d; p_{d}^{k}=q≠k and λ_{d}^{k}<δ_{∞} states that k forwarded a search on behalf of router q and λ_{d}^{k} is the reference distance used in the search; p_{d}^{k}=0 and λ_{d}^{k}<δ_{∞} states that k has been part of multiple searches regarding d and λ_{d}^{k} is the smallest reference distance used in such searches. In an example embodiment, α^{k} is true (T) if router k has been properly initialized, which means that an initialization period longer than LT (e.g., 5LT) has elapsed since the router started or rebooted, and is false (F) otherwise.

### 2.2 Methods

In an embodiment, different algorithms are discussed herein that describe the operation of the method 500, 550. In one embodiment, these algorithms are Safe Cycle-Free Routing Information Protocol (SCRIP) in pseudo-code. In one embodiment, one or more of these algorithms are included in the acyclical routing module 150. In an example embodiment, these algorithms assume that routers send data packets reliably after waiting for short or long time intervals, and that all destinations are of interest to all routers. Slightly different algorithms would be needed if unreliable message transmissions were used and not all destinations were of interest to all routers. The algorithms used by a router to forward data packets to neighbors are part of the data-plane and are not part of the definition of SCRIP.

In an embodiment, a first algorithm will now be discussed that is used to initialize the routers in the network. Table 1 below shows one example embodiment of this first algorithm.

TABLE 1
Algorithm 1 Procedure Initialize

```
INPUT: tₘᵢₙ, LT, RT^{k}, NT^{k}, LWT^{k}
N^{k} + [n | ∃(k,n)]; σ^{k} = T;
vₖ^{k} = T; [symbol] ₖ^{k} = [symbol] ;  rₖ^{k} = [symbol] ;  sₖ^{k} = k; Sₖ^{k} = [symbol] ;  pₖ^{k} = 0;
∧ₖ^{k} = δ_{∞}
for each n ∈ N^{k} do
  l(k,n) = weight of link (k,n): LTₙ^{k} = LT;
  δₙₙ^{k} = δ_{∞}; vₙₙ^{k} = T; δₖₙ^{k} = δ_{∞}: vₖₙ^{k} = T
end for
add U(k,k,T,δ [symbol] ,δ₀) to M^{k}
% send a first “hello” update % [symbol]
indicates data missing or illegible when filed
```

In one embodiment, the first algorithm is called once an initialization period at router k elapses following its restart. In this embodiment, a router k is shown being initialized with a defined neighbor set, which is applicable for a computer network with wired links. In an example embodiment, the routing table 305 data fields are initialized with the following values: σ^{k}=T, δₖ^{k}=rₖ^{k}==δ₀ and sₖ^{k}=k for k itself where δ₀ means a distance assigned to the destination d; and for the neighbor table 303 data fields are initialized for each defined neighbor q∈N^{k}δ_{kq}^{k}=δ_{∞}, ϑ_{kq}^{k}=T, δ_{qq}^{k}=δ_{∞} and ϑ_{qq}^{k}=T to indicate that no update has been received from q. Router k immediately sends a data packet with a single update U(k, 0, T, δ₀, δ₀).

In one embodiment, a second algorithm is employed to perform periodic messaging between the routers. Table 2 below shows one example embodiment of this second algorithm.

TABLE 2
Algorithm 2 Procedure Send

INPUT: M^{k}
if (M^{k} = ϕ) then add U(k,0,T,δ_{0,}δ₀) to M^{k}
for each n ∈ N^{k} do send M^{k} to n
UT^{k} = tₘₐₓ; M^{k} = ϕ

In an embodiment, to perform this periodic messaging, the router k maintains a timer UT^{k} to ensure that it sends a data packet soon after it updates its routing table 305 or decides to forward or respond to a query (e.g., request control packet 401) and sends routing messages often enough to inform its neighbors of its presence. In an example embodiment, if a router k needs to send a data packet with updates, it does so after a minimum amount of time tam has elapsed from the time it sent its prior routing message. In the absence of update messages needed to reflect changes to its routing table 305, a router sends an update message with a “hello” update U(k, k, T, δ₀, δ₀) to simply update the lifetime entries maintained for itself by its neighbors no later than tₘₐₓ seconds from the time it sent its last message. The timer tₘₐₓ is shorter than the maximum lifetime LT of the link weight values in the link weight bale 301. In an example embodiment, router k sets UT^{k} equal to tₘₐₓ after sending an update message, and sets UT^{k} equal to tₘᵢₙ after preparing updates or queries to be sent in response to an input event. The second algorithm listed in Table 2 shows one example embodiment of the steps involved in sending a routing message after the timer UT^{k} expires.

In an embodiment, router k updates the link weight table 301 (LWT^{k}) when an adjacent outgoing link (k, q) changes its weight l(k, q). In another embodiment, router k updates the neighbor table 303 (NT^{k}) and the routing table 305 (RT^{k}) when any type of input event occurs, such as when an adjacent outgoing link changes its weight, an immediate neighbor router fails to send updates before the lifetime for its link weight table 301 entry expires, or a routing message M_{q} is received from a neighbor. Tables 3-6 below depict an example embodiment of algorithms including steps that are employed in performing these updates.

TABLE 3
Algorithm 3 Procedure Neighbor Timeout

```
INPUT: N, NT^{k}, LWT^{k}, M^{k}
for each q ∈ N^{k} do
  if LT_{q}^{k} = 0 then
    for each d ∈ N do
      δ_{dq}^{k} = δ_{∞}; v_{dq}^{k} = T;
      call Procedure Update (U(d,k,T,δ_{∞},δ_{∞}), q)
    end for
  end if
end for
if ([M^{k} ≠ ϕ] ∧ [UT^{k} > tₘᵢₙ]) then UT^{k} = tₘᵢₙ
```

TABLE 4
Aigorithm 4 Procedure Link-Weight Change (l(k,q))

INPUT: N, NT^{k}, M^{k}
for each d ∈ N do
call Procedure Update·(U(d,k,v_{dq}^{k},δ_{∞},δ_{dq}^{k}), q)
end for
if ([M^{k} ≠ ϕ] ∧ [UT^{k} > tₘᵢₙ]) then UT^{k} = tₘᵢₙ

TABLE 5
Algorithm 5 Procedure Message

```
INPUT: q, N, N^{k}, M [symbol] , LT, LWT^{k}
if ([M [symbol]  is recieved] ∧ [σ^{k} = T] ) then
  LT [symbol] ^{k} = LT
  for each U(d,n_{d}^{q},v_{d}^{q},ρ_{d}^{q},δ_{d}^{q}) ∈ M [symbol]  do
    call Procedure Update ( U(d,n_{d}^{q},v_{d}^{q},ρ_{d}^{q},δ_{d}^{q}), q )
  end for
  if ([M^{k} ≠ ϕ] ∧ [UT^{k} > tₘᵢₙ]) then UT^{k} = tₘᵢₙ
end if [symbol]
indicates data missing or illegible when filed
```

TABLE 6
Algorithm 6 Procedure Update

```
INPUT: LT, LWT^{k}, NT^{k}, RT^{k}, U(d,n_{d}^{q},v_{d}^{q},ρ_{d}^{q},δ_{d}^{q}), q
LT_{q}^{k} = LT % update lifetime for neighbor q %
if (d = n_{d}^{q}) % a hello update % then
  if ([ [symbol] _{qq}^{k} = δ_{∞}] ∧ [δ_{kq}^{k} = [symbol] ]) % the first hello update
  from q % then [symbol]
    _{qq}^{k} = δ₀; v_{qq}^{k} = T; v_{q}^{k} = T; δ_{q}^{k} = l(k,q)
    for each j ∈ N do
      if (vⱼ^{k} = T) then add U(j,q,T,rⱼ^{k},δⱼ^{k}) to M^{k}
    end for [symbol]
    nd M^{k} to q % update q for all destinations with
    valid vouchers in [symbol] ing table %
  end if
  return
end if
δ_{dq}^{k} = δ [symbol]  % update NT^{k} %
if (v_{d}^{k} = T) then v_{dq}^{k} = v_{d}^{q}
if ([v_{d}^{k} = F] ∧ [v_{d}^{q} = T] ∧ [r_{d}^{k} ≥ ρ_{d} [symbol] ]) then v_{dq}^{k} = T
S* = [symbol] , V = 0; l = 0
for each n ∈ N^{k} do
  if ([r_{d}^{k} > δ_{dn}^{k}] ∧ [ [symbol] _{dn}^{k} = T]) then S* = S* ∪ [n]
  if (v_{dn}^{k} = T) then V = V = 1; if (δ [symbol] ^{k} = δ_{∞}) then
  I = I + 1;
end for
if ([ S* ≠ [symbol]  ] ∨ [ I = |N^{k}| ]) % V is satisfied % then
  δ [symbol]  = δ_{d}^{k}; r [symbol]  = r_{d}^{k}; δ_{d}^{k} = Min(δ_{dn}^{k} + I(k,n)); [symbol]
  _{d}^{k} = Min(n ∈ S_{d}^{k} | δ_{dn}^{k} + l(k,n) = δ_{d}^{k});
  if ([ V = |N^{k}| ] ∨ [ I = |N^{k}| ]) then r_{d}^{k} = δ_{d}^{k};
  call Procedure Valid-Voucher ( U(d,n_{d}^{q},v_{d}^{q},ρ_{d}^{q},δ_{d}^{q}), q
  )
else
  δ_{d}^{k} = δ_{dx}_{_{d}}^{k}^{k} + I(k,s_{d}^{k}); v_{d}^{k} F; for each n ∈ N^{k} do
  v_{dn}^{k} = F end for:
  if (δ_{d}^{k} = δ_{∞}) then [symbol] _{d}^{k} = 0
  call Procedure
  Invalid-Voucher ( U(d,n_{d}^{q},v_{d}^{q},ρ_{d}^{q},δ_{d}^{q}), q )
end if [symbol]
indicates data missing or illegible when filed
```

In an embodiment, a router k detects that a neighbor q just became active when it receives a “hello” update from q and its local state for q has δ_{qq}^{k}=δ_{kq}^{k}=δ_{∞}, which indicates that no messages were being received over link (k, q). As the algorithm in Table 6 above states, in this case, router k immediately sends a routing message for each destination for which it can offer a valid voucher.

In an embodiment, router k can be in one of two routing states for a destination d depending on the value of its voucher ϑ_{d}^{k} (e.g., from the voucher field 306). In one embodiment, router k (e.g. node 110c) has a valid value in the voucher field 306 for a record 302 associated with a destination d (ϑ_{d}^{k}=T) only if it can either: (a) vouch for one or more acyclic paths to the destination d because one or more of its neighbors (e.g. neighbor node 110b) has reported a valid voucher value and a reference distance value that is smaller than the reference distance value stored in the reference distance field 310 at k; or (b) state that it cannot reach d because all its neighbors (e.g. each of nodes 110a, 110b, 110d, 110e) have reported a distance equal to δ_{∞}. This condition can be stated formally as follows:

ϑ:(∃q [symbol] N^{k}([r_{d}^{k}>δ_{dq}^{k}]∨[ϑ_{dq}^{k}=T])∨(∀q∈N^{k}(δ_{dq}^{k}=δ_{∞}))) (1)

If ϑ is true then router k updates its routing table 305 data as follows:

ϑ_{d}^{k}←T; S_{d}^{k}←{q∈N^{k}|(r_{d}^{k}>δ_{dq}^{k})∧[ϑ_{dq}^{k}=T]} (2)

In an embodiment, equation 2 represents that the voucher value of the voucher field 306 is set to true and S_{d}^{k} represents all neighbor routers who each can attest for an acyclical path to the destination d that is less than the reference distance value stored in the reference distance field 310 at the router k.

δ_{d}^{k}←Min{δ_{dq}^{k}+l(k,n)|n∈S_{d}^{k}} (3)

s_{d}^{k}←Min{n∈S_{d}^{k}|δ_{dq}^{k}+l(k,n)=δ_{d}^{k}} (4)

if ([ϑ_{d}^{k}=T]∧[∀q∈N^{k}([ϑ_{dq}^{k}=T]∨[δ_{dq}^{k}=δ_{□}])])

then r_{d}^{k}←δ_{d}^{k} (5)

It follows from equations 2 through 5 that the value of r_{d}^{k} (e.g., reference distance value in the distance field 308) can be set equal to δ_{d}^{k} (e.g., minimum distance value in the reference distance field 308) only when its own voucher is valid and either all its neighbors provide valid vouchers or all its neighbors declared d to be unreachable. In one embodiment, in step 563 the router k chooses next hops to destination d (e.g., stored in next hop field 312) using the current value of r_{d}^{k} as its reference point to enforce ordering along paths.

In one embodiment, in step 555 router k cannot vouch for acyclic paths to destination d if ϑ is false. In this embodiment, in step 555 router k must set ϑ_{d}^{k}=F and start a search for a neighbor router or a remote router that can vouch for an acyclic path that is shorter than the distance value at k when ϑ was still satisfied, which equals r_{d}^{k}. Router k tracks which neighbor can vouch for an acyclic path that router k can use to make ϑ true again, and resets all the vouchers from its neighbors to F to start its search. Furthermore, to avoid routing cycles, router k does not change its best next hop to d (e.g., next hop value in the next hop field 312) until it obtains at least one response to its search that makes ϑ true again. This can be stated as follows:

ϑ_{d}^{k}←F; ∀q∈N^{k}(ϑ_{d}^{k}←F)

δ_{d}^{k}←δ_{ds}_{_{d}}_{^{k}}^{k}+l(k,s_{d}^{k}); if (δ_{dq}^{k}=δ_{∞}) then s_{d}^{k}←0 (6)

In an embodiment, in steps 553 and 555, once ϑ is false, an update from any neighbor q with a valid voucher (ϑ_{d}^{q}=T) and a reference distance that is shorter than the reference distance at (k_{d}^{k}>ρ_{d}^{q}) makes ϑ true again (e.g. in a second iteration of step 553), because the path from q to d consists of the concatenation of an acyclic path from q to another router p that attests to the acyclic nature of a path to d such that δ_{d}^{p}=ρ_{d}^{q}<r_{d}^{k}. Alternatively, router k sets ϑ to true again if all its neighbors declare d to be unreachable (see Equation 1).

In an embodiment, in steps 553 router k interprets a valid voucher from a neighbor q as an independent attestation to the acyclic nature of a path from q to d if ϑ is true. However, in one embodiment, in step 553 router k resets all its neighbor voucher values to F when becomes false. Accordingly, while ϑ is false router k must interpret a valid voucher from a neighbor q as a relative attestation whose truth value at k depends on whether the path offered by q takes into account the reference distance r_{d}^{k} communicated by k in its request. This is stated formally as follows as part of the method used to update the neighbor table 303:

ϑ_{dq}^{k}←δ_{q}^{d}; if (ϑ_{d}^{k}==T) then ϑ_{dq}^{k}←ϑ_{d}^{q}

if ([ϑ_{d}^{k}←=F]∧[ϑ_{d}^{q}=T]∧[r_{d}^{k}≥ρ_{d}^{q}]) then ϑ_{d}^{qk}←T (7)

In an embodiment, routers use updates with valid distance vouchers to inform their neighbors of new distance values, and use updates with invalid distance vouchers to start or propagate search requests (e.g., step 555) for acyclic paths to destinations. In one embodiment, the steps that router k takes in response to an input event depend on whether ϑ in equation 1 is true after the neighbor table 303 has been updated according to equation 7 as a result of the input event. In an example embodiment, when ϑ is true after an input event, router k updates its routing table 305 according to equations 2 through 5 and either sends an update, a response, or forwards a request depending on the value of δ_{d}^{k}, its search tuple [ρ_{d}^{k}, λ_{d}^{k}], and the update that may be received from a neighbor q.

In some embodiments, the status of links between the routers may change during an input event and consequently the search request signals (from step 555) previously transmitted may need to be adjusted based on this input event. In one embodiment, a router k detects a link-cost change or receives an update U(d, n_{d}^{q}, T, ρ_{d}^{q}, δ_{d}^{q}) from q∈N^{k}. If the minimum distance stored in field 308 was a finite value (e.g., δ_{d}^{k}<δ_{∞}) before the input event, then router k sends an update if δ_{d}^{k} changed its value or needs to send a response to a prior search request (from step 555). Router k knows that it must send a response to a prior search request (from step 555) if: (a) λ_{d}^{k}<δd∞, which indicates that router k has a pending request; and (b) ρ_{d}^{k}<λ_{d}^{k}, which indicates that a remote router vouches for an acyclic path that satisfies the pending search request. In this case, its update U(d, n_{d}^{k}, T, ρ_{d}^{k}, δ_{d}^{k}) states n_{d}^{k}=p_{d}^{k} and ρ_{d}^{k}=ρ_{d}^{k}; router k also resets its search tuple [p_{d}^{k}, λ_{d}^{k}] to [0, δ_{∞},]. If δ_{d}^{k} changed its value and router k is neither part of a search (λ_{d}^{k}=δ_{∞}) nor can it satisfy a pending request (ρ_{d}^{k}>λ_{d}^{k}), then router k sends an update U(d, 0, r_{d}^{k}, δ_{d}^{k}).

In one embodiment, the values stored in the routing table 305 may need to be adjusted based on an input event (e.g., change in the status of one or more links between the routers). In one embodiment, if δ_{d}^{k}=δ_{∞} before the input event, then router k updates its routing table 305 according to equations 2 through 5 and sends an update U(d, n_{d}^{k}, T, ρ_{d}^{k}, δ_{d}^{k}) with n_{d}^{k}=p_{d}^{k} and p_{d}^{k}=r_{d}^{k} if either the value of δ_{d}^{k} changed (δ_{d}^{k}<δ_{∞}) or the input event allowed ϑ to be satisfied, which router k identifies because r_{d}^{k}<δ_{∞} before the input event in that case.

In an embodiment, in step 555 router k receives a search request packet U(d, n_{d}^{q}, F, ρ_{d}^{q}, δ_{d}^{q}) from neighbor q∈N^{k}. This scenario was discussed with respect to the nodes 110a, 110d, 110e receiving the search request packets 411a, 411b, 411c in FIG. 4C. In one embodiment, router k can vouch for an acyclic path that is shorter than the reference distance in the request if the following condition is satisfied:

R: (ϑ_{d}^{q}=T)∧(ρ_{d}^{q}>δ_{ds}_{_{d}}_{^{k}}^{k}) (8)

If R in equation 8 is satisfied, then router k sends an update U(d, q, T, ρ_{d}^{k}, δ_{d}^{k}) with ρ_{d}^{q}=δ_{ds}_{_{d}}_{^{k}}^{k} as a response to q. This scenario was discussed with respect to node 110d sending the response control packet 4I3 in FIG. 4C. If R in equation 8 is not satisfied, then router k propagates or stops the search depending on the values of [ρ_{d}^{k}, λ_{d}^{k}] and n_{d}^{q} and sends an update depending on the value of δ_{d}^{k}. In one example embodiment, in responding to a search request if router k was asked to help (i.e., n_{d}^{q}=k or n_{d}^{q}=0), then router k checks the value of ρ_{d}^{k}. If λ_{d}^{k}>ρ_{d}^{q}, then router k (e.g. node 110d in FIG. 4C) forwards the request U(d, s_{d}^{k}, F, ρ_{d}^{k}, δ_{d}^{k}) with ρ_{d}^{k}=ρ_{d}^{q}, sets p_{d}^{k}=q if λ_{d}^{k}=δ_{□} to remember that a response is needed for q or multiple neighbors, and sets λ_{d}^{k}=Min{λ_{d}^{k}, ρ_{d}^{k}} to remember the smallest reference distance stated in a request. On the other hand, router k stops the request if λ_{d}^{k}≤ρ_{d}^{k}, because it already has forwarded a prior request that can satisfy the request from q. In this case, k sets p_{d}^{k}=0 to ensure that a future response is sent back to all its neighbors. Router k sends an update U(d, q, T, ρ_{d}^{k}, δ_{∞}) with ρ_{d}^{k}=ρ_{d}^{q} if δ_{d}⁵=δ_{∞} to inform q that it cannot reach d, or sends an update U(d, q, T, r_{d}^{k}, δ_{d}^{k}) if δ_{d}^{k}<δ_{□} and changed in value.

In an embodiment, if a router did not receive the search request signal (from step 555), it may still send an update to the router that sent the search request. In this embodiment, if router k was not asked to help (i.e., n_{d}^{q}≠k and n_{d}^{q}≠0) and R is not satisfied, router k sends an update in two cases. In one embodiment, router k sends an update U(d, q, T, r_{d}^{k}, δ_{d}^{k}) if δ_{d}^{k}<δ_{∞} changed as a result of the request from q. Alternatively, router k sends a response U(d, q, T, ρ_{d}^{k}, δ_{d}^{k}) with ρ_{d}^{k}=ρ_{d}^{q} if δ_{d}^{k}=δ_{□} to inform q that it cannot reach d.

In an embodiment, when the voucher value ϑ is false after an input event, router k updates the link weight table 301 and the neighbor table 303 as stated in equation 6 and sends an update, a response, or forwards a request depending on the value of δ_{d}^{k}, its search tuple [ρ_{d}^{k}, λ_{d}^{k}], and the update that may be received from a neighbor q.

In an embodiment, during an input event, the router k detects a link-cost change or receives an update U(d, n_{d}^{q}, T, ρ_{d}^{q}, δ_{d}^{q}) from q∈N^{k}. In this embodiment, router k sends a request packet U(d, n_{d}^{k}, F, ρ_{d}^{k}, δ_{d}^{k}) with ρ_{d}^{k}=r_{d}^{k} and n_{d}^{k}=s_{d}^{k} if r_{d}^{k}<λ_{d}^{k}, because any pending request does not satisfy its own reference distance. If this is the case, router k updates λ_{d}^{k}=Min{λ_{d}^{k}, r_{d}^{k}} to remember the smallest reference distance used in a request, and updates p_{d}^{k}=k if λ_{d}^{k}=δ_{□} or p_{d}^{k}=0 if λ_{d}^{k}<δ_{∞} to remember how to forward responses to its request. On the other hand, if r_{d}^{k}≥λ_{d}^{k}, router k knows that it has sent a prior request with a smaller reference distance than its own and simply updates p_{d}^{k}=0 to remember that it is involved in multiple requests.

In an embodiment, the router k receives a request U(d, n^{q}_{d}, T, ρ_{d}^{q}, δ_{d}^{q}) from q∈N^{k}. In this embodiment, if ρ_{d}^{k}<λ_{d}^{k} then router k sends a request U(d, 0, F, ρ_{d}^{k}, δ_{d}^{k}) to all its neighbors with ρ_{d}^{k}=ρ_{d}^{q}, and updates λ_{d}^{k}=ρ_{d}^{q} and p_{d}^{k}=0. Otherwise, if ρ_{d}^{k}≥λ_{d}^{k}, router k knows it has sent a request that satisfies the request from q. In this case, router k updates p_{d}^{k}=0 to remember that it is involved in multiple requests, and sends an update U(d, q, T, ρρ_{d}^{k}, δ_{∞}) with ρ_{d}^{k}=ρ_{d}^{q} if δ_{d}^{k}=δ_{∞}, to inform q that it cannot reach d.

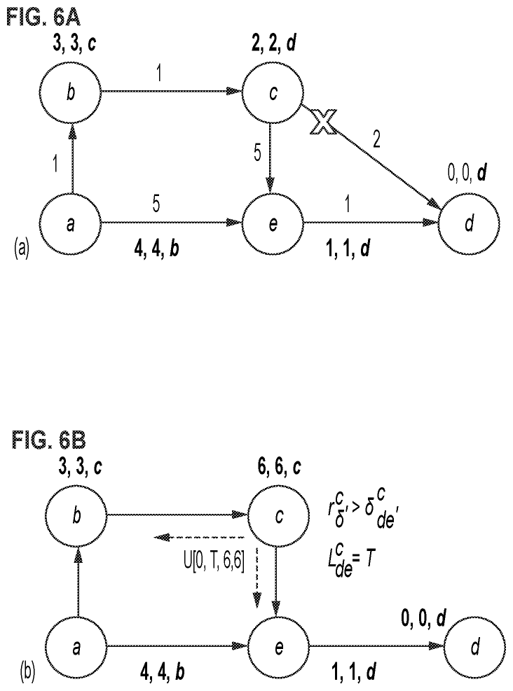

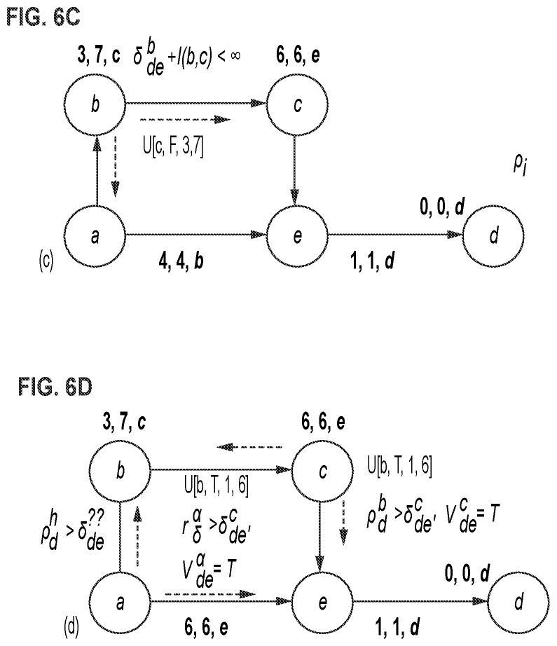

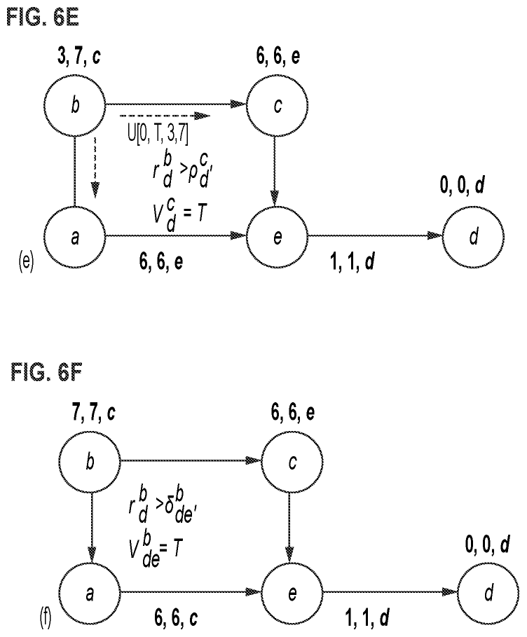

An example embodiment of using the methods 500, 550 of FIGS. 5A and 5B to achieve fast converge in a network of nodes is now discussed. FIGS. 6A through 6F are block diagrams that illustrate an example of stages of achieving network convergence using the method of FIGS. 5A and 5B, according to an embodiment. In an embodiment, for each node depicted in the network of FIGS. 6A through 6F, a status [a, b, c] is provided next to each router where a is the reference distance value for that router, b is the minimum distance value for that router, and c is the next best hop for that router. In an example embodiment, these status values are stored in fields of the routing table 305 for that router. In contrast to conventional methods, routers may have multiple next hops to destinations, which are indicated by arrowheads. In one embodiment, an update sent by router k omits destination d and is denoted by U(n_{d}^{k}, ϑ_{d}^{k}, ρ_{d}^{k}, δ_{d}^{q}) and the Boolean values of true and false for vouchers are denoted by T and F, respectively.

In an embodiment, FIG. 6A shows that the link (c, d) failed between routers c and d. In one embodiment, in step 553 the link c determines that an invalidation event is present, because no response packet was received from router d. Subsequently, in step 555 router c sent a search request to other routers including router e and received a response packet from router e in step 551. Then in step 553 router c determined that the response packet from router e includes a valid voucher field (step 553) and that the reference distance value (1) from router e is less than the reference distance value (2) stored in the reference distance field 310 at router c. Subsequently in steps 559, 561 and 563 the router c determined the total distance based on a sum of the reference distance at router e (1) and the distance of the link c, e (5) so the total distance if 6. Router c then stores this total distance value in the reference distance field 310 at router c. Subsequent to this, FIG. 6B shows that router c sends an update with a valid distance voucher after the failure of link (c, d) because its reference distance value increased to 6. As FIG. 6C shows, the update from router c causes router b to start a search for a router that can vouch for an acyclic path because ϑ is not satisfied by any of the neighbors of router b. Accordingly, the update from b is a search request signal (step 555) for a router to vouch for a path shorter than r_{d}^{b}=3 by stating ϑ_{d}^{b}=F, ρ_{d}^{k}=3 and δ_{d}^{b}=7 in its update. Router b keeps s_{d}^{b}=c while its search proceeds. This is the case because the total distance at router b based on using router c as the next hop is δ_{dc}^{b}+l(b, c)=7<δ_{∞}; however, router b cannot change its next hop until it receives an update vouching for an acyclic path shorter than its reference distance value r_{d}^{b}=3.

In an embodiment, FIG. 6D shows that routers c and a send back updates to router b with valid distance vouchers, because ϑ is satisfied at each router and each has a neighbor that reported a distance smaller than ρ_{d}^{b}=3. In one embodiment, FIGS. 6E and 6F show that the updates from a and c allow router b to set δ_{d}^{b}=7 and ϑ_{d}^{b}=T. Furthermore, router b makes r_{d}^{k}=δ_{d}^{k}=7 in FIG. 6F because all neighbors of router b provided updates with valid vouchers and reference distances smaller than r_{d}^{k}=3.

In an embodiment, this example illustrates that SCRIP is acyclic while routers converge quickly to optimal paths. A router that needs to search for routers that can vouch for acyclic paths and can trust the first update with a valid distance voucher and a reference distance that is shorter than its own reference distance.

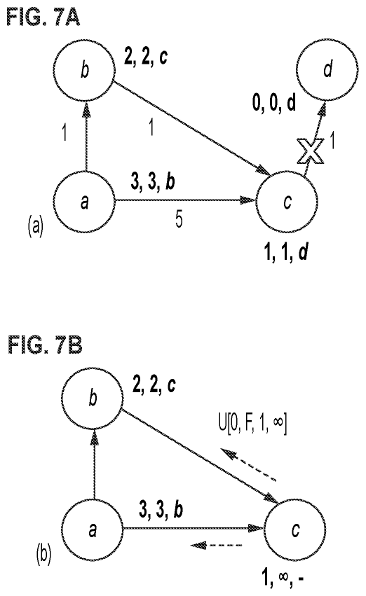

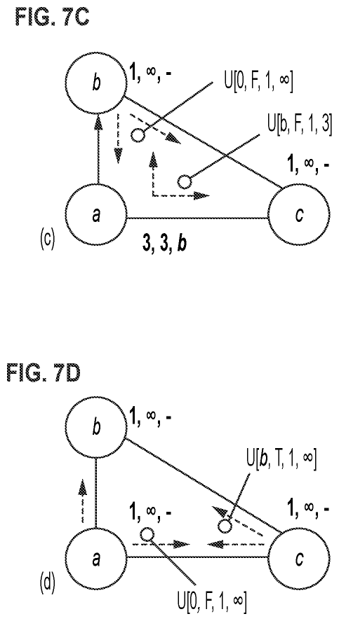

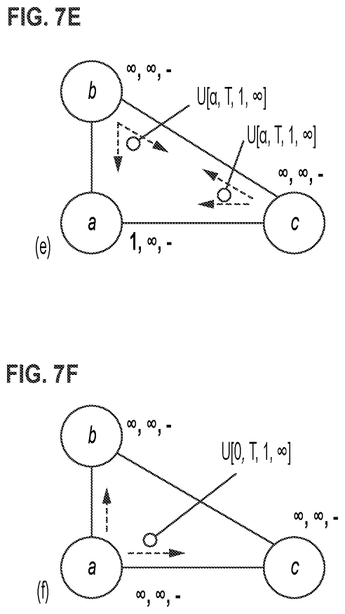

FIGS. 7A through 7F are block diagrams that illustrate an example of using the method of FIGS. 5A and 5B after a network is partitioned, according to an embodiment. In one embodiment, FIG. 7A shows the routing state of routers when link (c, d) fails and destination d is unreachable. In one embodiment, FIGS. 7B through 7D show that all routers reach a distance of 1 in just three steps. All routers are able to increase the values of their reference distances to equal their distances after each receives updates from all neighbors reporting distances equal to δ_{∞} (FIGS. 7E and 7F).

### 2.3 Theory

In this section, to further explain the embodiments, various theorems are presented that validate methods previously described for determining safe acyclic routing in a communication network. However, the embodiments are not limited by the validity or completeness of these theorems. The intuitive argument for the correctness of SCRIP derives from Theorem 1. P_{d}^{k}(n) denotes the n^{th} path from router k to destination d and ω_{d}^{k}(n) is a weight of the path P_{d}^{k}(n). An acyclic path to a destination satisfies total ordering T along paths. Total ordering T along the path P_{d}^{k}(n) created by concatenating link (k, s_{d}^{k}(n)) with path P_{d}^{s}^{_{d}}^{^{k}}⁽ⁿ⁾(m) (the mth path from s_{d}^{k}(n) to d) is given by:

T: ω_{d}^{s}^{_{d}}^{^{k}}⁽ⁿ⁾(m)<ω_{d}^{k}(n) (9)

The acyclic path also satisfies augmenting such a path with a single link or with another acyclic path that also satisfies T, given that any link weight is a positive real number and the weight of any path is also a positive real number. Thus, if a router n attests with a distance voucher that a path P_{d}ⁿ is acyclic, adding a link (k, n) or another acyclic path P_{d}^{k} to path P_{d}ⁿ a way that ϑ in equation 1 is satisfied implies that T is satisfied by each router on the extended path P_{d}^{k}, which equals (k, n)/P_{d}ⁿ or Pₙ^{k}P_{d}ⁿ. The following theorems formalize this argument to prove that SCRIP is acyclic and converges to optimal paths within a finite time.

In an embodiment, Theorem 2 is that the SCRIP is acyclic for any destination d. Let C denote the proposition that SCIP is executed correctly at every router for destination d. The proof needs to show that C→T* at every router k.

From equation 1, let ϑ denote the proposition that router k executes SCRIP correctly while having a valid voucher for destination d. Let W denote the proposition that router k executes SCRIP correctly while waiting for a valid voucher for destination d. C≡ϑ∨W at any given router k for destination d. From Theorem 1, the proof can show that (ϑ∨W)→T*≡(ϑ→r)∧(W→T*) and the argument proceeds by contradiction showing that (ϑ→T*)∨(W→T*) is a contradiction.

Assume that (ϑ∨W) is true but T becomes false at time t_{L}, when router k either makes another router r its new next hop or waits for a neighbor to provide a valid distance voucher for destination d and does not select a new best next hop to destination d. Given that T is true prior to the routing-table update decision made by router k at time t_{L}, T is satisfied by routers r and path P_{d}^{r} at time t_{L}, is acyclic with weight ω_{d}^{r}. Furthermore, if router k uses a neighbor router n as its best next hop to destination d prior to negating T at time t_{L}, then path P_{d}ⁿ time t_{L}, is acyclic and has a weight ω_{d}ⁿ.

(ϑ→T*): if router k makes router r its new best next hop to destination d at time t_{L}, then the weight of path P_{d}^{k} equals l(k, r)+ω_{d}^{r} at that time. However, this is a contradiction to the assumption that T is false, because l(k, r)>0 and hence ω_{d}^{k}>ω_{d}^{r}.

(W→T*): if router k does not change its best next hop to destination d at time tₗ, then router k either has no next hop to destination d or keeps n as its next hop to d. T cannot be negated in the first case because P_{d}^{k} does not exist. In the second case, P_{d}^{k} remains equal to l(k, n)+ω_{d}ⁿ, which is a contradiction to T being false, because l(k, n)>0 and hence ω_{d}^{k}>ω_{d}ⁿ.

The following theorems show that SCRIP converges to optimal distances for destinations that can be reached, and to δ_{∞} for unreachable destinations.

Lemma 1: Valid distance vouchers propagate through acyclic paths. Proof: Let P denote the proposition that valid distance vouchers propagate through acyclic paths. The proof then needs to show that C→P. By definition, a valid distance voucher attests that a path is acyclic and hence A→P. From Theorem 1, it is true that A↔T* and hence T*↔*P. The result then follows from Theorem 2, because (C→T*)n(T*→P)→(C→P).

Theorem 3: SCRIP converges to optimal routes for any given destination within a finite time after network changes stop occurring in a finite connected network. Proof of this theorem must show that C→O for any destination d. The proof proceeds by showing that C∧O is a contradiction. Accordingly, assume that SCRIP works correctly and also assume that router k converges incorrectly with δ_{d}^{k}>δ_{d}*^{k}, where δ_{d}*^{k} is the optimum distance from router k to destination d.

Given that the network is connected and finite, all acyclic paths in the network are finite and it takes a finite time for updates starting from destination d to propagate over any acyclic path. Distance δ_{d}*^{k} corresponds to an acyclic path from k to d through some neighbor router s∈S_{d}^{k} because it is optimum. From Lemma 1 and the fact that C is true, this implies that router k must receive an update from router s reporting δ_{d}*^{k} and a valid voucher for destination d. However, this is a contradiction to C being true, because then equations 1 through 5 would require router k to make δ_{d}*^{k} its distance to destination d.

Theorem 4: SCRIP converges to δ_{∞} at every router of a finite connected network component for any destination that is unreachable from the network component within a finite time after network changes stop occurring. Proof: Let I denote the proposition that all routers in a connected network component converge to a distance of δ_{∞} for a destination d that is not reachable from the network component. The proof needs to show that C→I and proceeds by showing that C∧I is a contradiction. Assume that no network changes occur after time tₙ and I is true with at least one router nₖ converging to a finite distance for d at time tₖ≥tₙ. Because C is true, any router nₖ that has a valid voucher and a distance δ_{d}ⁿ^{ᵢ}<δ_{∞} at time tₖ must have a next-hop neighbor nᵢ₋₁ ∈Nⁿ^{ᵢ} such that δ_{di}_{ᵢ₋₁}ⁿ^{ᵢ}<δ_{d}ⁿ^{ᵢ} and ϑ_{dn}_{ⁱ⁻¹}ⁿ^{ᵢ}=T. It follows from Lemma 1 that there must be an originating router no that issued a valid voucher and a distance δ_{d}ⁿ^{ₒ}<δ_{∞} that allowed updates with valid vouchers and finite distances to propagate along one or more acyclic paths to nₖ before time tₖ. Furthermore, because C is true, router nₒ must be a neighbor of destination d. However, this is a contradiction because d is not in the connected component starting at least starting at time t₀, and hence no router in the connected component can consider itself being a neighbor of d after some finite time t₀>tₙ.

Theorem 5: The reference distance used in SCRIP for any given destination converges to the correct distance value for that destination at every router within a finite time after network changes stop occurring in a network. Proof: Let E denote the fact that the reference distance equals the minimum distance at each router for a destination d within a finite time after network changes stop occurring in a network. The proof needs to show that (C∧|O∨I|)→E, which is equivalent to (|C∧0|I→E)∧(|C∧I|→E). The proof proceeds by showing that (|C∧0|→E)∨(|C∧I|→E) is a contradiction.

|C∧O|→E: Assume that all routers have converged to their optimum distances for any given destination d at time to. This implies that ϑ is satisfied at every router and each router updates its routing state according to equations 2 through 5. Router k can have r_{d}^{k}<δ_{d}^{k} indefinitely after time tₒ only if at least one neighbor reports an invalid voucher for d indefinitely, which is a contradiction to the correct operation of SCRIP and the fact that ϑ is satisfied at every router.

|C∧O|→E: Assume that all routers have converged to a distance of δ_{∞} to destination d at time tₒ. This implies that d is not reachable from any router because C is true. For the sake of contradiction, assume that router k has converged to r_{d}^{k}<δ_{d}^{k}=δ_{∞} at time tₖ tₖ≥tₒ and maintains that value of r_{d}^{k} indefinitely. Because C is true, each router q∈N^{k} must report a distance equal to δ_{∞} by time tₒ, which is a contradiction to r_{d}^{k}<δ_{d}^{k}=δ_{∞}, given that the updates received by k from all its neighbors satisfy ϑ, which means that router k must set r_{d}^{b}=δ_{d}^{k} according to equations 2 through 5 within a finite time after tₒ.

### 2.4 Performance Measurements

The time complexity TC (number of steps) and communication complexity CC (number of messages) needed by all routers to obtain acyclic paths to a given destination after a single link-weight increase are used to compare the performance of SCRIP with other routing protocols and show that using distance vouchers is inherently more efficient than prior approaches.

In the following, H denotes the network diameter in number of hops, A denotes the average degree of a router, T denotes a timer delay that by design must be much longer than the time an update takes to traverse the network diameter, and N and E are the number of routers and number of links in the network, respectively.

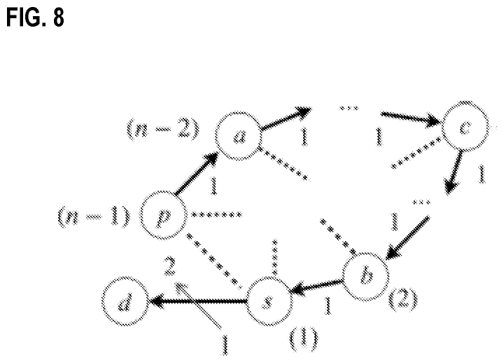

FIG. 8 is a block diagram that illustrates an example of using the method of FIGS. 5A and 5B after a link cost increase in the network, according to an embodiment. In one embodiment, FIG. 8 shows an example of a single link-cost increase that impacts distances to destination d at all routers other than d. The numbers in parenthesis denote distances to d, solid links with arrowheads are part of shortest paths to d and each has a weight of 1, and links in dashed lines are assumed to have large weights that make the chain involving all nodes other than d correspond to the shortest paths to d.

Using Destination Sequence Numbers (s): A single link weight increase may make all routers unable to trust their distances to destination d (see FIG. 8). The updates carrying a larger distance with an incremented sequence number (e.g., k+1) must be sent in the reverse direction of the shortest paths that are affected, which involves N−1 hops in the worst case (FIG. 8). All those routers must then wait for destination d to send an update with a new sequence number (e.g., k+2). The new sequence number from d validates the new shortest distances to d as updates percolate to all routers, which necessarily involves N−1 hops. Furthermore, a timer delay T is incurred waiting for the periodic transmission of the next sequence number from d. Therefore, TCₛ=O (2N+T) and CCₛ=O(E).

By contrast, the time and communication complexity for routing protocols based on link-state information is only TCₛ=Θ(H+T) and CCₛ=Θ(E), because link-state updates propagate independently of next-hop routing choices, and routers have inconsistent topologies until a link state with the most recent sequence number is stored at every router.

Using Inter-Nodal Coordination (c): Using diffusing computations is more efficient than conventional methods that use propagation of information with feedback (PIF) and link-reversal algorithms and is the technique assumed in this analysis. A single link-weight increase may cause the start of a diffusing computation, and queries, replies, and final updates may have to traverse the directed acyclic graph (DAG) formed by the routers affected by the computation. In the worst case (FIG. 8), the DAG involves most network links and N−1 routers (e.g., FIG. 8). Therefore, TCₛ=O(3N) and CCₛ=O(6E). However, this is a loose bound, because an update traversing a single hop may result in convergence.

Using Distance Vouchers (v): From FIG. 8, when router s sends an update with a larger distance resulting from link (s, d) increasing in weight, it makes router b start a search for an acyclic path that satisfies its reference distance. In the worst case, the request propagates to all routers other than d (see FIG. 8), which takes N−1, and involves most links. However, a router closer to d or d itself must be able to send a response and the response follows the original request along the same reverse shortest paths to d immediately (e.g., s sends a response immediately to b in FIG. 8) or just after a few steps. Therefore, TCᵥ=O(N) and CCᵥ=O(2E). This is a loose bound; as the example in FIGS. 6A through 6F illustrates, a search request may traverse a single hop.

### 3. Hardware Overview

FIG. 9 is a block diagram that illustrates a computer system 900 upon which an embodiment of the invention may be implemented. Computer system 900 includes a communication mechanism such as a bus 910 for passing information between other internal and external components of the computer system 900. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of one or more methods described herein.

A sequence of binary digits constitutes digital data that is used to represent a number or code for a character. A bus 910 includes many parallel conductors of information so that information is transferred quickly among devices coupled to the bus 910. One or more processors 902 for processing information are coupled with the bus 910. A processor 902 performs a set of operations on information. The set of operations include bringing information in from the bus 910 and placing information on the bus 910. The set of operations also typically include comparing two or more units of information, shifting positions of units of information, and combining two or more units of information, such as by addition or multiplication. A sequence of operations to be executed by the processor 902 constitutes computer instructions.

Computer system 900 also includes a memory 904 coupled to bus 910. The memory 904, such as a random access memory (RAM) or other dynamic storage device, stores information including computer instructions. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of computer instructions. The computer system 900 also includes a read only memory (ROM) 906 or other static storage device coupled to the bus 910 for storing static information, including instructions, that is not changed by the computer system 900. Also coupled to bus 910 is a non-volatile (persistent) storage device 908, such as a magnetic disk, optical disk, or FLASH-EPROM, for storing information, including instructions, that persists even when the computer system 900 is turned off or otherwise loses power.

Information, including instructions, is provided to the bus 910 for use by the processor from an external input device 912, such as a keyboard containing alphanumeric keys operated by a human user, or a sensor. A sensor detects conditions in its vicinity and transforms those detections into signals compatible with the signals used to represent information in computer system 900. Other external devices coupled to bus 910, used primarily for interacting with humans, include a display device 914, such as a cathode ray tube (CRT) or a liquid crystal display (LCD), for presenting images, and a pointing device 916, such as a mouse or a trackball or cursor direction keys, for controlling a position of a small cursor image presented on the display 914 and issuing commands associated with graphical elements presented on the display 914.

In the illustrated embodiment, special purpose hardware, such as an application specific integrated circuit (IC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

In the illustrated computer used as a router, the computer system 900 includes switching system 930 as special purpose hardware for switching information flow over a network. Switching system 930 typically includes multiple communications interfaces, such as communications interface 970, for coupling to multiple other devices. In general, each coupling is with a network link 932 that is connected to another device in or attached to a network, such as local network 980 in the illustrated embodiment, to which a variety of external devices with their own processors are connected. In some embodiments an input interface or an output interface or both are linked to each of one or more external network elements. Although three network links 932a, 932b, 932c are included in network links 932 in the illustrated embodiment, in other embodiments, more or fewer links are connected to switching system 930. Network links 932 typically provides information communication through one or more networks to other devices that use or process the information. For example, network link 932b may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990. A computer called a server 992 connected to the Internet provides a service in response to information received over the Internet. For example, server 992 provides routing information for use with switching system 930.

The switching system 930 includes logic and circuitry configured to perform switching functions associated with passing information among elements of network 980, including passing information received along one network link, e.g., 932a, as output on the same or different network link, e.g., 932c. The switching system 930 switches information traffic arriving on an input interface to an output interface according to pre-determined protocols and conventions that are well known. In some embodiments, switching system 930 includes its own processor and memory to perform some of the switching functions in software. In some embodiments, switching system 930 relies on processor 902, memory 904, ROM 906, storage 908, or some combination, to perform one or more switching functions in software. For example, switching system 930, in cooperation with processor 904 implementing a particular protocol, can determine a destination of a packet of data arriving on input interface on link 932a and send it to the correct destination using output interface on link 932c. The destinations may include host 982, server 992, other terminal devices connected to local network 980 or Internet 990, or other routing and switching devices in local network 980 or Internet 990.

Computer system 900 also includes one or more instances of a communications interface 970 coupled to bus 910. Communication interface 970 provides a two-way communication coupling to a variety of external devices that operate with their own processors, such as printers, scanners and external disks. In general, the coupling is with a network link 932 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. As another example, communications interface 970 may be a modulator-demodulator (modem) to provide a wireless link to other devices capable of receiving information wirelessly. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 970 sends and receives electrical, acoustic or electromagnetic signals, including infrared and optical signals, that carry information streams, such as digital data.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 902, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 902, except for carrier waves and other signals.

Logic encoded in one or more tangible media includes one or both of processor instructions on a computer-readable storage media and special purpose hardware, such as ASIC *920.

The invention is related to the use of computer system 900 for implementing the techniques described herein. According to one embodiment of the invention, those techniques are performed by computer system 900 in response to processor 902 executing one or more sequences of one or more instructions contained in memory 904. Such instructions, also called software and program code, may be read into memory 904 from another computer-readable medium such as storage device 908. Execution of the sequences of instructions contained in memory 904 causes processor 902 to perform the method steps described herein. In alternative embodiments, hardware, such as application specific integrated circuit 920, may be used in place of or in combination with software to implement the invention. Thus, embodiments of the invention are not limited to any specific combination of hardware and software.

The signals transmitted over network link 932 and other networks through communications interface 970, carry information to and from computer system 900. Computer system 900 can send and receive information, including program code, through the networks 980, 990 among others, through network link 932 and communications interface 970. In an example using the Internet 990, a server 992 transmits program code for a particular application, requested by a message sent from computer 900, through Internet 990, ISP equipment 984, local network 980 and communications interface 970. The received code may be executed by processor 902 as it is received, or may be stored in storage device 908 or other non-volatile storage for later execution, or both. In this manner, computer system 900 may obtain application program code in the form of a signal on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red a carrier wave serving as the network link 932. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to perform one or more steps of a method described herein and includes, for instance, the processor and memory components described with respect to FIG. *9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of a method described herein.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1005 also stores the data associated with or generated by the execution of one or more steps of the methods described herein.

### 4. Alternative, Extensions and Modifications

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the items, element or step modified by the article.

What is claimed is:

1. A method for routing in a communications network comprising:
receiving at a local router, from a first router, a request packet that indicates a first destination value;
determining whether a first entry in a routing table data structure at the local router indicates the first destination value in a destination field and a valid value in a voucher field; and
sending to the first router a response packet with a first distance value from a distance field of the first entry only when the voucher field holds a valid value; and
forwarding the request packet to a different second router when the voucher field holds an invalid value.

2. The method as recited in claim 1, wherein: the request packet also indicates a reference distance value; and, said sending to the first router the response packet is only performed if the voucher field holds the valid value and the reference distance value is greater than the first distance value.

3. The method as recited in claim 1, further comprising:
receiving at the local router, from a third router, a response packet that indicates a second destination value and a valid or invalid value for a voucher and a second distance value;
storing in the routing table data structure at the local router a second entry that indicates the second destination value in the destination field of the second entry and the valid or invalid value in the voucher field of the second entry and the second distance value in the distance field of the second entry.

4. The method as recited in claim 3, further comprising upon detection at the local router of an invalidation event involving the second destination value based on the response packet indicating the invalid value, storing the invalid value in the voucher field in the second entry in the routing table data structure at the local router.

5. The method as recited in claim 4, further comprising upon the detection at the local router of the invalidation event involving the second destination value, sending to neighboring routers a message indicating the second destination value and the invalid value for the voucher.

6. The method as recited in claim 3, wherein the response packet indicates the valid value and a reference distance value in a reference distance field of the second entry is greater than the second distance value and wherein the method further comprises:
determining a total distance value based on the second distance value and a link distance value indicating a distance between the local router and the third router; and
storing in the routing table data structure the total distance value in the distance field of the second entry.

7. The method as recited in claim 6, wherein the local router receives a plurality of response packets from a respective plurality of third routers, wherein each of the response packets indicates the second destination value and the valid value and wherein the determining the total distance comprises determining a respective total distance for each respective third router and wherein the storing the total distance value in the distance field comprises storing a smallest value among the plurality of total distance values in the distance field.

8. The method as recited in claim 7, further comprising storing the smallest value among the plurality of total distance values in the reference distance field of the second entry.

9. The method as recited in claim 6, further comprising storing an identifier of the third router in a next best hop field of the second entry based on the total distance value being less than the reference distance value.

10. A method for routing in a communications network comprising:
receiving at a local router, from a first router, a response packet that indicates a first destination value, a valid or invalid value for a voucher and a first distance value;
storing in a routing table data structure at the local router a first entry that indicates the first destination value in a destination field of the first entry and the valid or invalid value in a voucher field of the first entry;
wherein the valid value is stored in the voucher field and a reference distance field in a reference distance field of the first entry is greater than the first distance value, the method further comprises;
determining a total distance value based on the first distance value and a link distance value indicating a distance between the local router and the first router; and
storing in the routing table data structure the total distance value in the distance field of the first entry.

11. The method as recited in claim 10, wherein the local router receives a plurality of response packets from a respective plurality of first routers, wherein each of the response packets indicates the first destination value and the valid value, wherein the determining the total distance comprises determining a respective total distance for each respective first router and wherein the storing the total distance value in the distance field comprises storing a smallest value among the plurality of total distance values in the distance field.

12. The method as recited in claim 10, wherein the invalid value is stored in the voucher field and the method further comprises sending to neighboring routers a message indicating the first destination value and the invalid value for the voucher.

13. A non-transitory computer-readable medium carrying one or more sequences of instructions, wherein execution of the one or more sequences of instructions by one or more processors causes the one or more processors to perform one or more of:
receive a request packet that indicates a first destination value at a local router from a first router;
determine whether a first entry in a routing table data structure at the local router indicates the first destination value in a destination field and a valid value in a voucher field;
send a response to the first router with a total distance based on the first distance value from a distance field of the first entry only when the voucher fields holds a valid value; and
forward the request packet to a different second router when the voucher fields holds an invalid value.

14. An apparatus comprising:
a local router comprising a transceiver configured to transmit or receive data packets;
at least one processor configured to be communicatively coupled with the transceiver; and
at least one memory including one or more sequences of instructions,
the at least one memory and the one or more sequences of instructions configured to, with the at least one processor, cause the apparatus to perform one or more of:
receive, at the transceiver, a request packet that indicates a first destination value from a first router;
determine, with the processor, whether a first entry in a routing table data structure at the local router indicates the first destination value in a destination field and a valid value in a voucher field;
send, with the transceiver, a response packet to the first router with a total distance based on the first distance value from a distance field of the first entry only when the voucher fields holds a valid value; and
forward, with the transceiver, the request packet to a different second router when the voucher fields holds an invalid value.
